(19) United States
(12) Patent Application Publication
(10) Pub. No.: US 2012/0077172 A1
(43) Pub. Date: Mar. 29, 2012

(54) PRESENTATION SYSTEM

(75) Inventors: Tohru WATANABE, Osaka (JP); Ryuhei AMANO, Osaka (JP); Noboru YOSHINOBE, Osaka (JP); Masafumi TANAKA, Osaka (JP); Kiyoko TSUJI, Osaka (JP); Kazuo ISHIMOTO, Osaka (JP); Toshio NAKAKUKI, Osaka (JP); Kaihei KUWATA, Osaka (JP); Masahiro YOSHIDA, Osaka (JP)

(73) Assignee: SANYO ELECTRIC CO., LTD., Osaka (JP)

(21) Appl. No.: 13/310,010

(22) Filed: Dec. 2, 2011

Related U.S. Application Data
(63) Continuation of application No. PCT/JP2010/062501, filed on Jul. 26, 2010.

(30) Foreign Application Priority Data
Jul. 27, 2009 (JP) 2009-174009

(51) Int. Cl. G09B 5/00

(52) U.S. Cl. 434/308

(57) ABSTRACT

A digital camera (1) performs shooting such that each student within a classroom is included in a subject, uses an optical flow to detect the action of standing up from a chair or the action of moving a mouth by a student who needs to be a speaker, thus specifies the position of the speaker (any of the students) on a shooting image and extracts image data on the face portion of the speaker. A PC (2) uses a projector (3) to display a material on a screen (4), and superimposes and displays, when the extracted image data is transferred from the digital camera (1), a picture of the face of the speaker on the screen (4) based on the extracted image data.

### BACKGROUND OF THE INVENTION

1. Field of the Invention

The present invention relates to a presentation system with which to proceed with learning, discussion or the like through the display of pictures.

2. Description of Related Art

In recent years, at educational sites, information terminals such as a PC (personal computer) and projectors have often been used; at such an educational site, the content of a material transmitted from an information terminal is displayed on the screen of a projector. Students in a classroom proceed with learning while watching the content displayed on the screen and listening to what a teacher is saying; in the course of this process, the students express their thoughts and the like at any time.

On the other hand, although quite a few classes are conducted for a small number of students (for about a few students), classes are often conducted with a large number of students arranged (for example, with a few tens of students arranged two-dimensionally). In the latter case, it is difficult for all students to listen to the remarks of the speaker while watching the face of a speaker (any of the students), with the result that the students other than the speaker often listen to the remarks while watching the screen, their notebook or the like.

However, it is common sense to watch the face of a speaker when listening to his remarks; it is possible to more often grasp, when listening to the remarks while watching the face of the speaker, the intension of the speaker that cannot be expressed with words. Since, in order to satisfactorily conduct a class, it is necessary for a teacher and a large number of students to communicate and cooperate with each other, it is believed that the students need to communicate with each other, and that, when the communication is performed with the face of the speaker being watched, the willingness of the students to join the class and the realism of the class are enhanced, and the advantages of group learning (such as the effect of enhancing the willingness to study due to competitiveness) can be utilized.

On the other hand, an educational style of using a pointing device such as a pen tablet to make students answer questions may be employed at educational sites. This educational style is an educational style that is derived from a conventional style of writing answers on paper with a pencil; the action of answering questions is performed depending on visual sense alone. If learning is performed while various human senses are being stimulated, it is possible to expect the enhancement of the willingness of students to study and their power of memory.

Although the problems at educational sites have been described, the same is true in academic presentations, conferences and the like.

### SUMMARY OF THE INVENTION

According to the present invention, there is provided a first presentation system including: an image sensing portion which performs shooting such that a plurality of persons are included in a subject and which outputs a signal indicating a result of the shooting; a speaker detection portion which detects, on an image, a speaker from the persons based on an output of the image sensing portion; and an extraction portion which extracts, from the output of the image sensing portion, image data on an image portion of the speaker, as speaker image data based on a result of the detection by the speaker detection portion, in which a picture based on the speaker image data is displayed, by the presentation system, on a display screen that the persons can visually recognize.

According to the present invention, there is provided a second presentation system including: a plurality of microphones which are provided to correspond to a plurality of persons, respectively and which output sound signals corresponding to sounds produced by the corresponding persons; a sound recognition portion which performs sound recognition processing based on an output sound signal of each of the microphones to convert the output sound signal of each of the microphones into character data; one or a plurality of display devices which the persons can visually recognize; and a display control portion which controls content of a display produced by the display device according to whether or not the character data satisfies a predetermined condition.

According to the present invention, there is provided a third presentation system including: an image sensing portion which shoots a subject and which outputs a signal indicating a result of the shooting; a microphone portion which outputs a sound signal corresponding to an ambient sound of the image sensing portion; and a speaker detection portion which detects a speaker from a plurality of persons based on an output sound signal of the microphone portion, in which an output of the image sensing portion with the speaker included in the subject is displayed, by the presentation system, on a display screen that the persons can visually recognize.

According to the present invention, there is provided a fourth presentation system including: an image sensing portion which shoots a plurality of persons and which outputs a signal indicating a result of the shooting; a personal image generation portion which generates, for each of the persons, based on an output of the image sensing portion, a personal image that is an image of the person so as to generate a plurality of personal images corresponding to the persons; and a display control portion which sequentially displays, by performing a plurality of steps for the display, the personal images on a display screen that the persons can visually recognize, in which, when a predetermined trigger signal is received, information that a person corresponding to a personal image displayed on the display screen needs to be a speaker is provided by the presentation system.

The significance and the effects of the present invention will be further apparent from the description of embodiments discussed below. However, the following embodiments are simply one embodiment of the present invention; the significance of the present invention and of the term of each constitutional requirement is not limited to the description of the embodiments below.

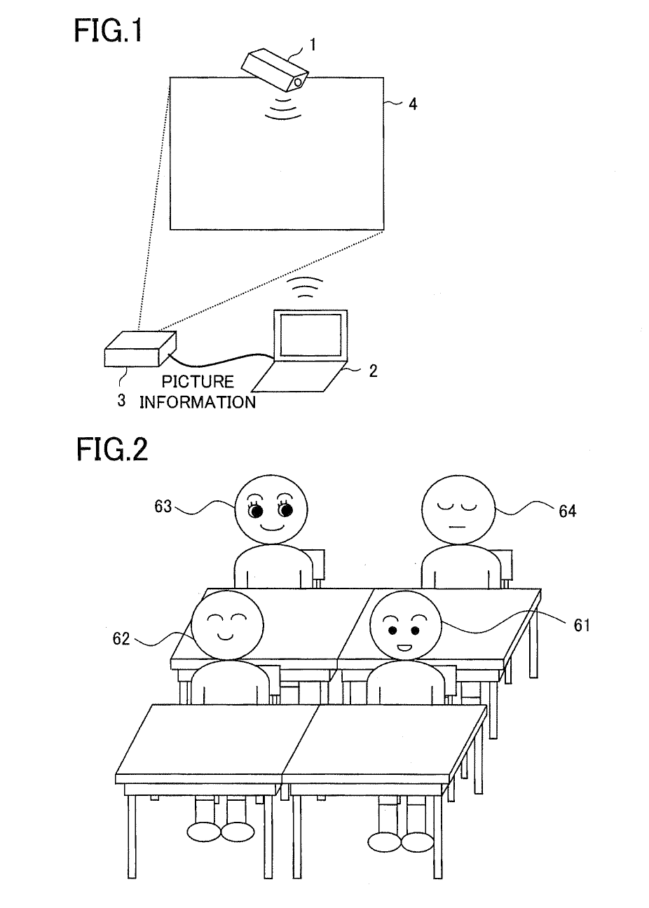

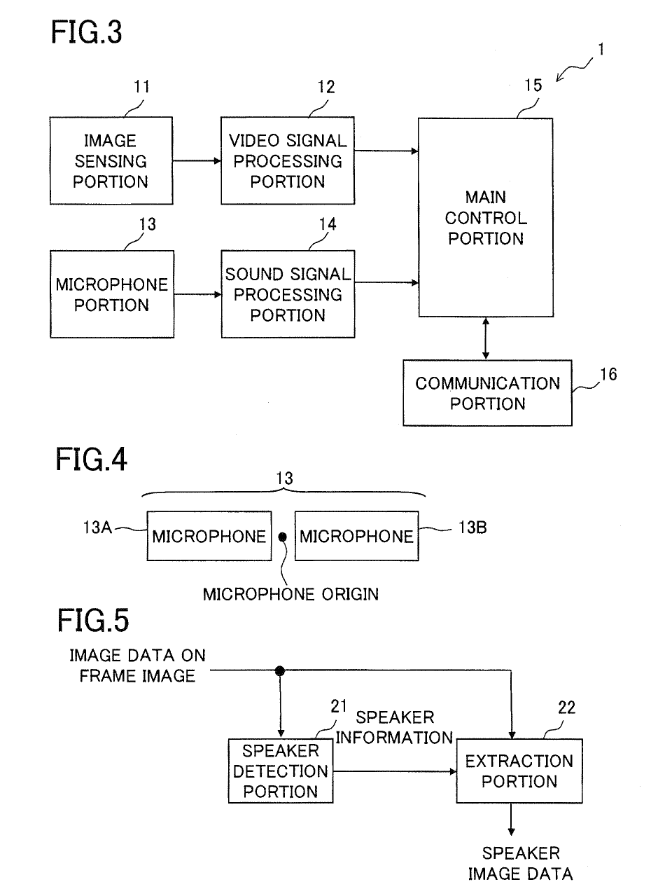

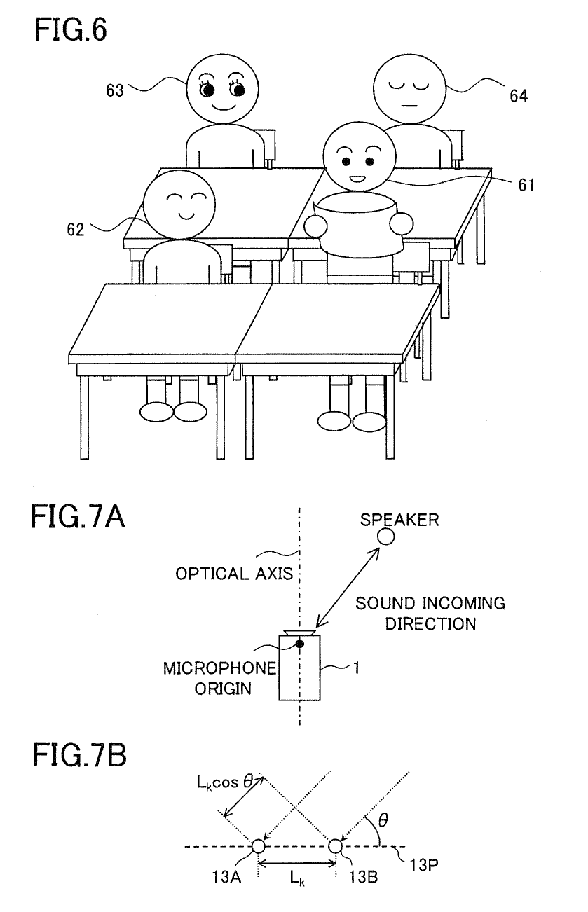

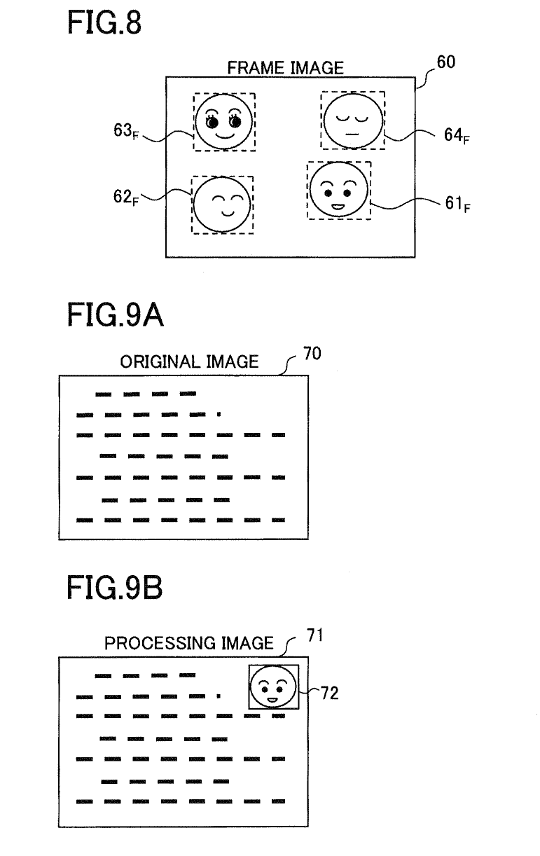

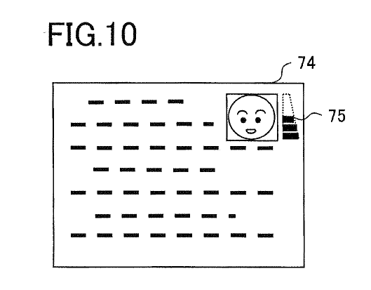

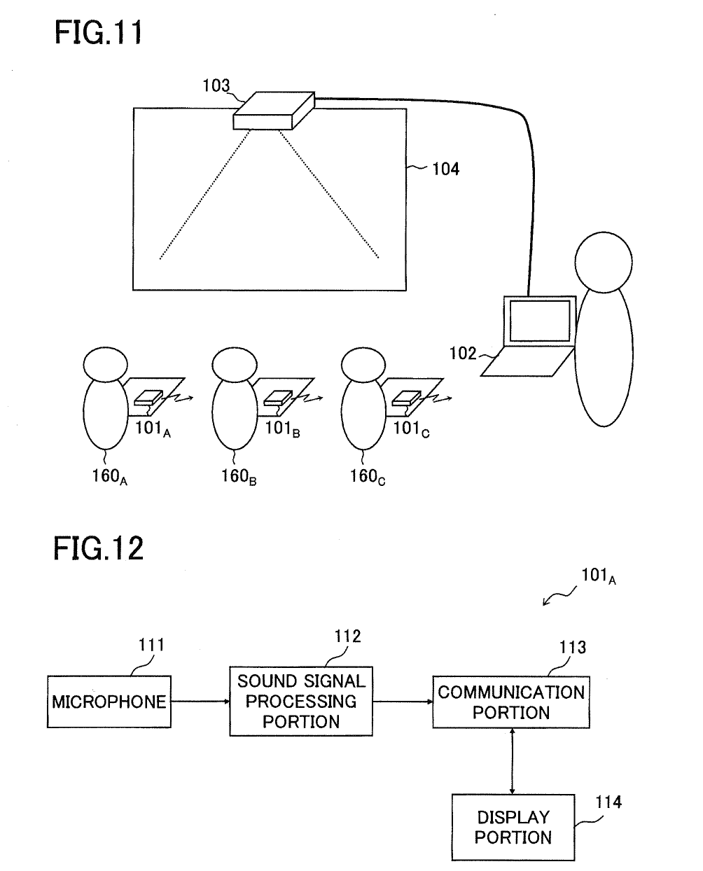

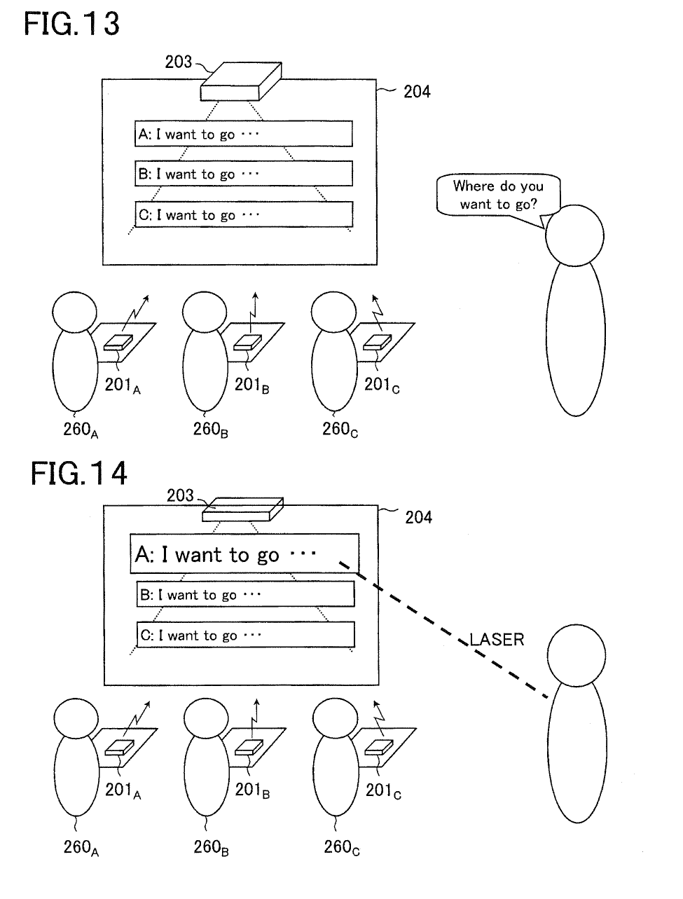

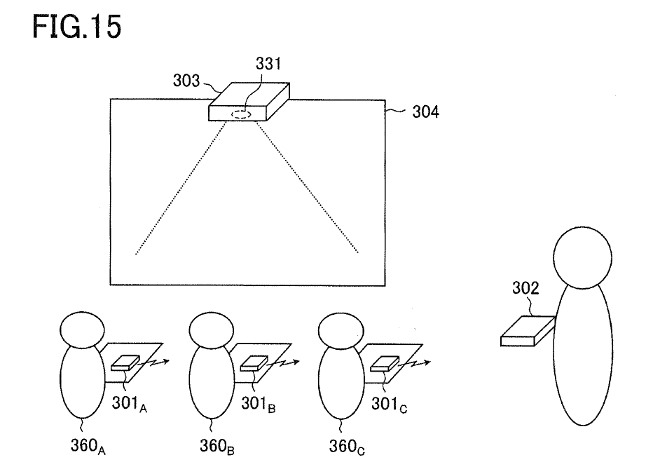

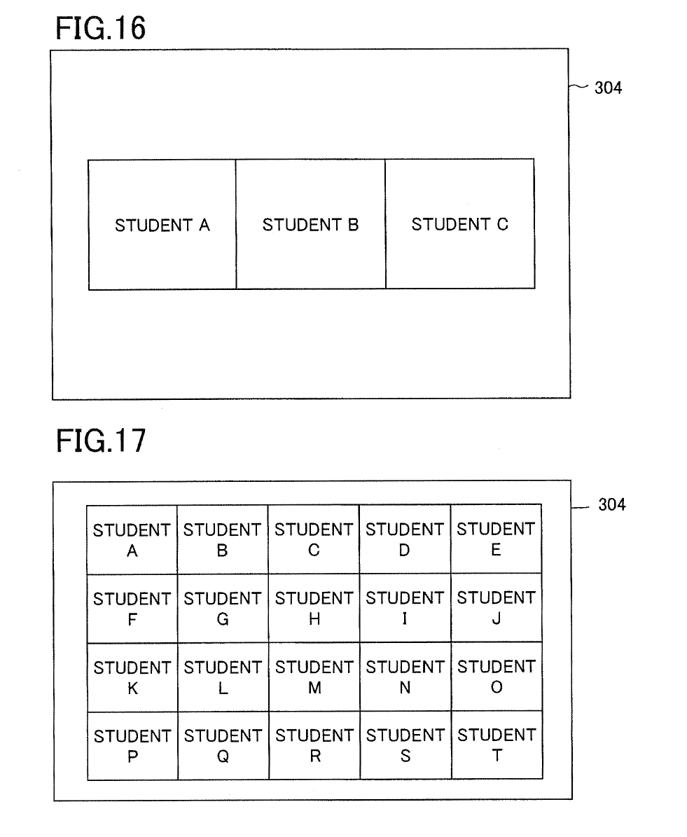

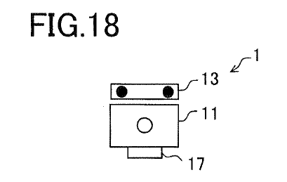

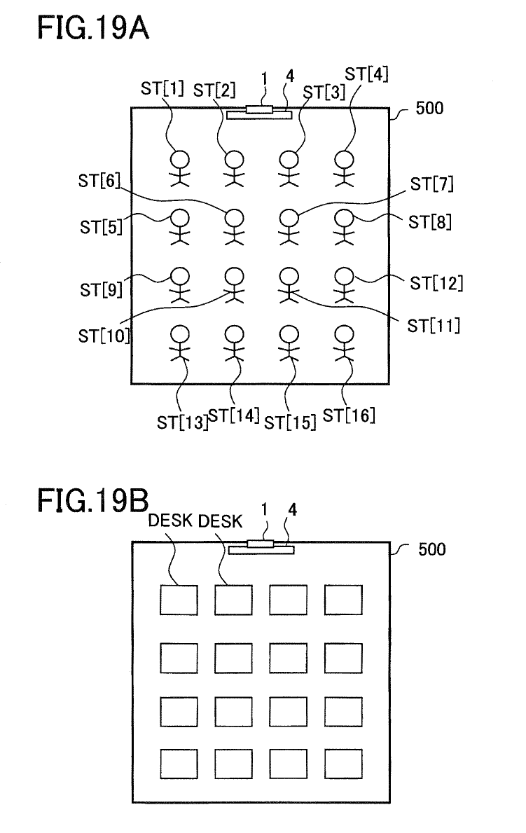

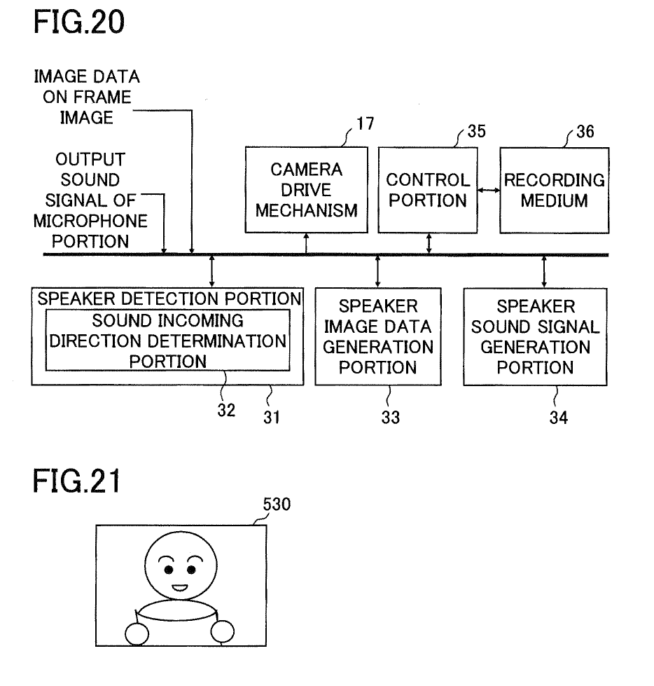

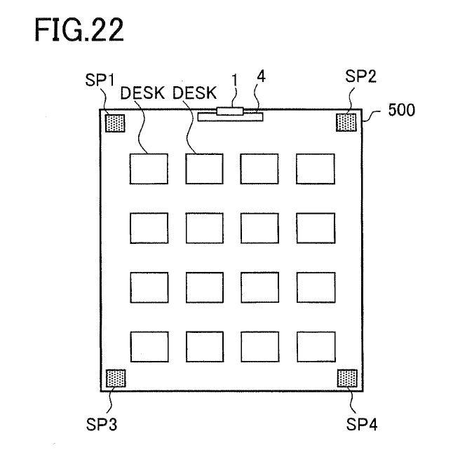

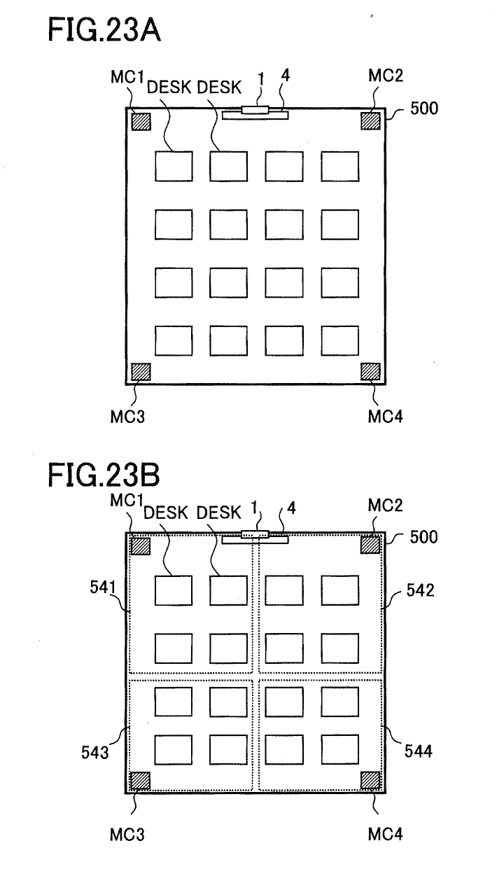

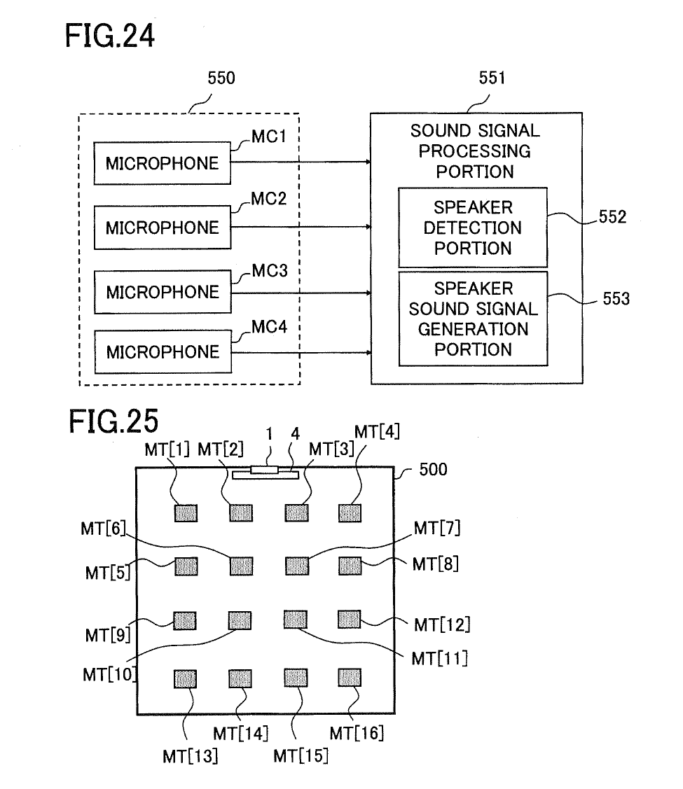

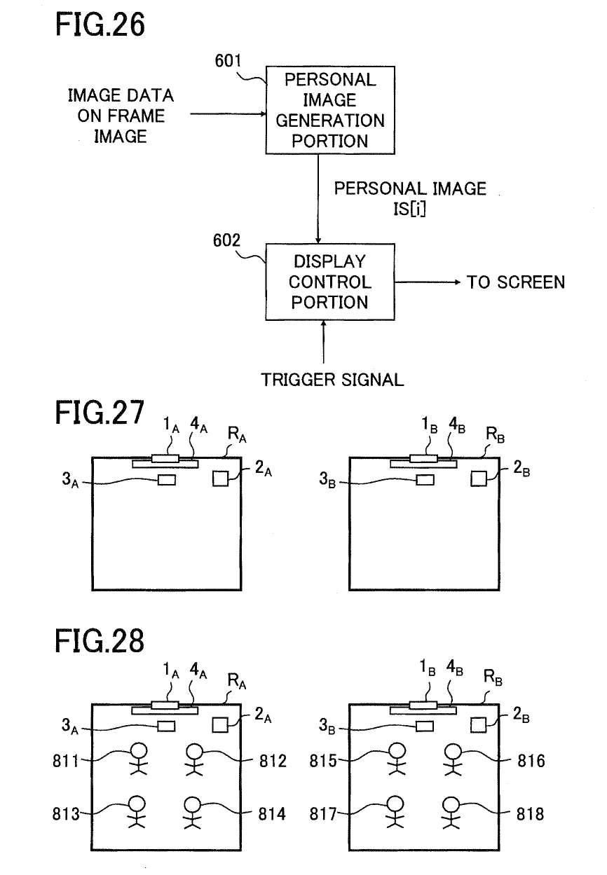

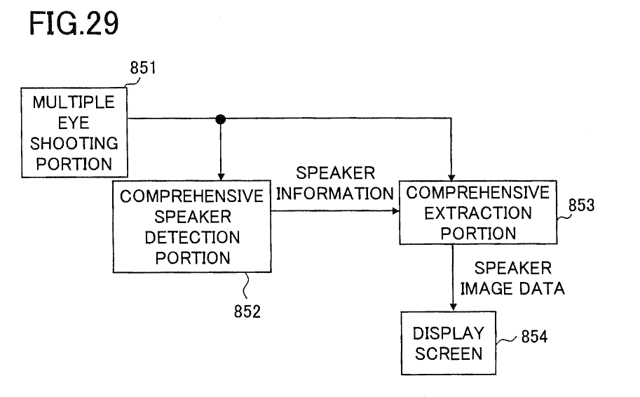

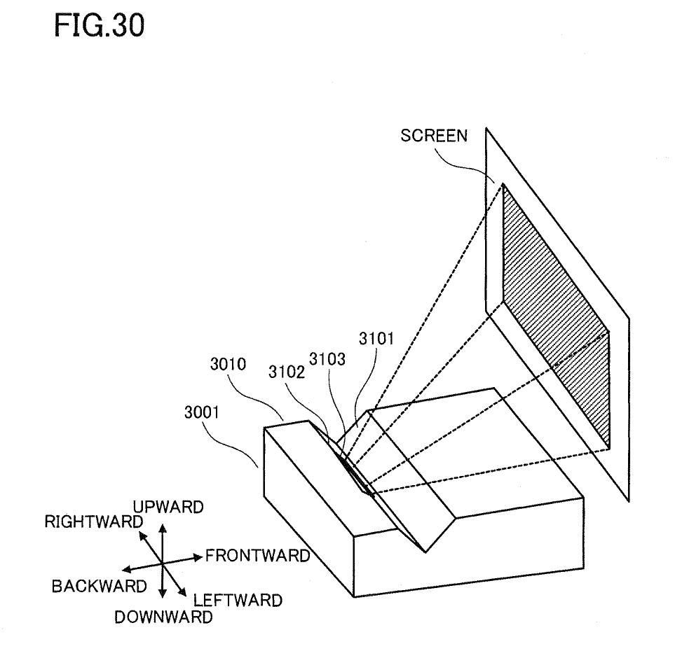

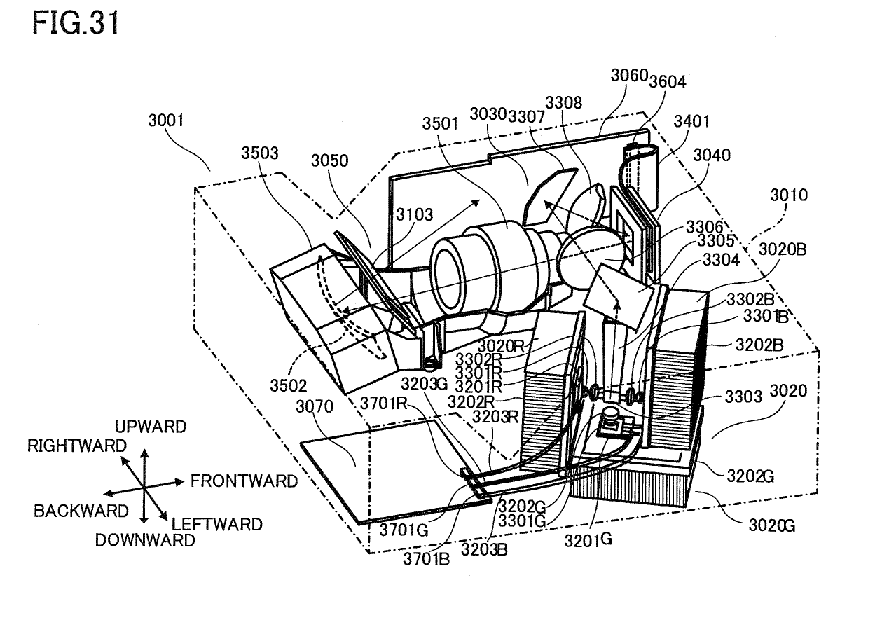

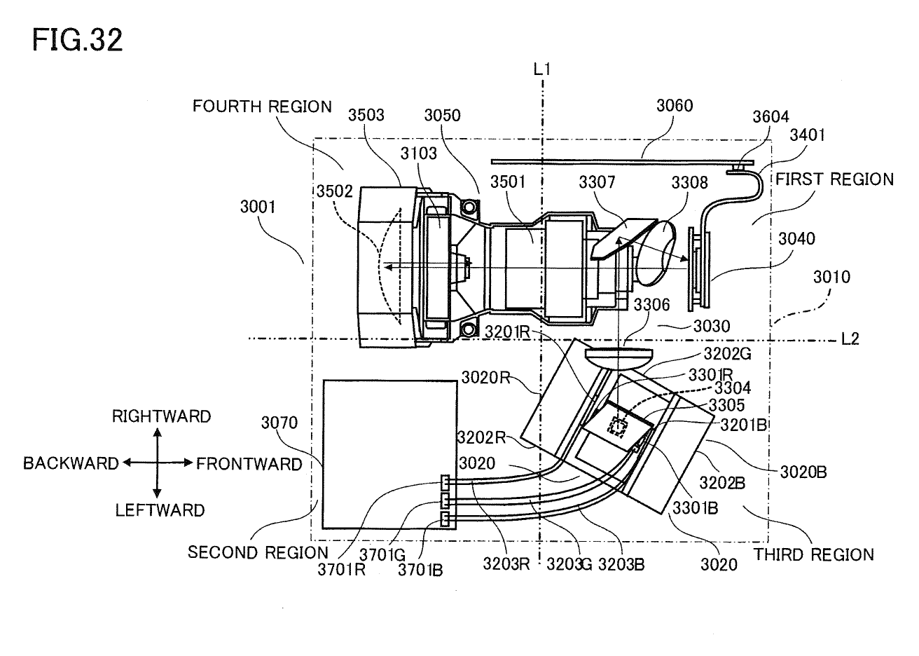

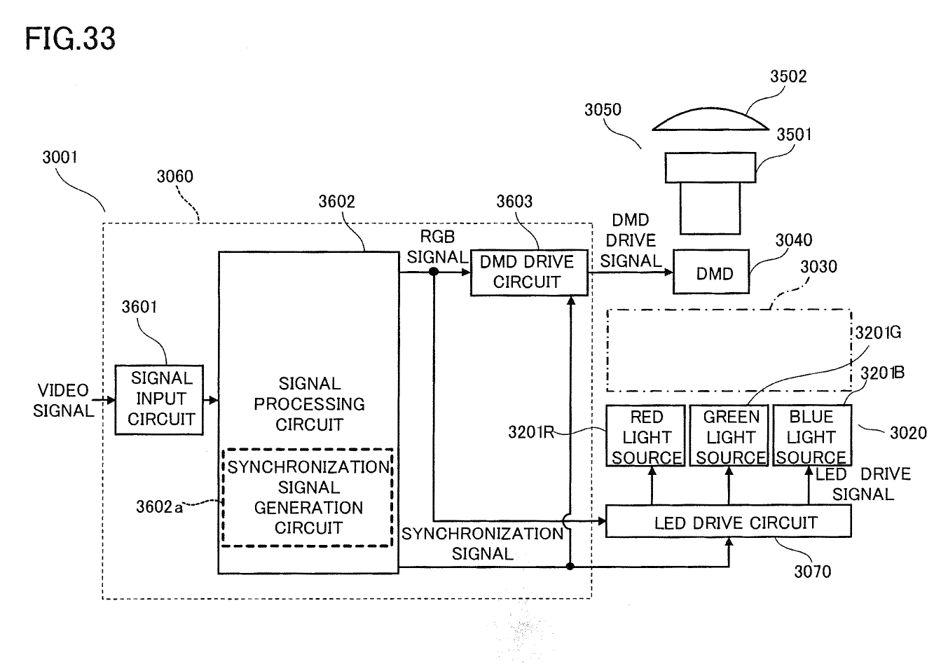

### BRIEF DESCRIPTION OF DRAWINGS

[FIG. 1] An overall diagram showing the configuration of an educational system according to a first embodiment of the present invention;

[FIG. 2] A diagram showing a plurality of persons (students) who utilize the educational system;

[FIG. 3] A schematic internal block diagram of a digital camera according to the first embodiment of the present invention;

[FIG. 4] A diagram showing the internal configuration of a microphone portion of FIG. 3;

[FIG. 5] A block diagram of a portion that is included in the digital camera of FIG. 3;

[FIG. 6] A diagram showing a state where, among the persons shown in FIG. 2, one person is standing up to speak;

[FIGS. 7A and 7B] A diagram showing a relationship between a speaker, a microphone origin and a sound incoming direction and a diagram illustrating a method of detecting the sound incoming direction, respectively, in the first embodiment of the present invention;

[FIG. 8] A diagram showing four face regions extracted from one frame image in the first embodiment of the present invention;

[FIGS. 9A and 9B] Diagrams showing examples of an image that needs to be displayed on the screen of FIG. 1;

[FIG. 10] A diagram showing an example of an image that needs to be displayed on the screen of FIG. 1;

[FIG. 11] A diagram showing the overall configuration of an educational system according to a second embodiment of the present invention along with users of the educational system;

[FIG. 12] A schematic internal block diagram of one of information terminals shown in FIG. 11;

[FIG. 13] A diagram showing the overall configuration of an educational system according to a third embodiment of the present invention along with users of the educational system;

[FIG. 14] A diagram showing the overall configuration of the educational system according to the third embodiment of the present invention along with users of the educational system; the diagram also showing how the content of a display on a screen is changed in comparison with FIG. 13;

[FIG. 15] A diagram showing the overall configuration of an educational system according to a fourth embodiment of the present invention along with users of the educational system;

[FIG. 16] A diagram showing an example of the content of the display on the screen in the fourth embodiment of the present invention;

[FIG. 17] A diagram showing another example of the content of the display on the screen in the fourth embodiment of the present invention;

[FIG. 18] A diagram schematically showing the configuration of a digital camera in a fifth embodiment of the present invention;

[FIGS. 19A and 19B] Diagrams illustrating an educational site in the fifth embodiment of the present invention;

[FIG. 20] A partial block diagram of an educational system in the fifth embodiment of the present invention;

[FIG. 21] A diagram showing an example of a frame image acquired by the digital camera in the fifth embodiment of the present invention;

[FIG. 22] A diagram showing how four loudspeakers are arranged within a classroom in the fifth embodiment of the present invention;

[FIGS. 23A and 23B] Diagrams illustrating an educational site in a sixth embodiment of the present invention;

[FIG. 24] A partial block diagram of an educational system in the sixth embodiment of the present invention;

[FIG. 25] A diagram illustrating an educational site in a seventh embodiment of the present invention;

[FIG. 26] A partial block diagram of an educational system in an eighth embodiment of the present invention;

[FIG. 27] A diagram showing two classrooms in a ninth embodiment of the present invention;

[FIG. 28] A diagram showing a state where students are held in each of the classrooms in the ninth embodiment of the present invention;

[FIG. 29] A partial block diagram of an educational system in the ninth embodiment of the present invention;

[FIG. 30] A diagram showing the appearance and configuration of a projector in a tenth embodiment of the present invention;

[FIG. 31] A perspective view showing the internal configuration of the projector in the tenth embodiment of the present invention;

[FIG. 32] A plan view showing the internal configuration of the projector in the tenth embodiment of the present invention; and

[FIG. 33] A block diagram showing the configuration of the projector in the tenth embodiment of the present invention.

### DETAILED DESCRIPTION OF THE PREFERRED EMBODIMENTS

Embodiments of the present invention will be specifically described below with reference to accompanying drawings. In the referenced drawings, like parts are identified with like symbols, and their description will not be repeated in principle.

### First Embodiment

A first embodiment of the present invention will be described. FIG. 1 is an overall diagram showing the configuration of an educational system (presentation system) according to the first embodiment. The educational system of FIG. 1 is configured to include a digital camera 1 that is an image sensing device, a personal computer (hereinafter abbreviated to a PC) 2, a projector 3 and a screen 4. FIG. 2 shows a plurality of persons who utilize the educational system. Although the following description is given on the assumption that the educational system is utilized at an educational site, the educational system can be utilized under various conditions such as academic presentations, conferences and the like (the same is true in the other embodiments, which will be described later). The educational system of the first embodiment can be employed at an educational site of students in an arbitrary age bracket. The persons shown in FIG. 2 are students at an educational site. The number of students is assumed to be four; the four students are represented as the four persons by symbols 61 to 64. However, the number of students is not limited as long as it is two or more. A desk is arranged in front of each of the students 61 to 64; under the conditions shown in FIG. 2, the students 61 to 64 sit on chairs individually allocated to the students.

FIG. 3 is a schematic internal block diagram of the digital camera 1. The digital camera 1 is a digital video camera that can shoot a still image and a moving image, and includes portions represented by symbols 11 to 16. A digital camera that will be described in any of embodiments to be discussed later can be assumed to be equivalent to the digital camera 1.

The image sensing portion 11 includes an optical system, an aperture and an image sensor that is formed with a CCD (charge coupled device), a CMOS (complementary metal oxide semiconductor) image sensor or the like. The image sensor of the image sensing portion 11 photoelectrically converts, through the optical system and the aperture, an optical image representing a subject that enters the image sensor, and outputs the resulting electrical signal indicating the optical image to the video signal processing portion 12. The video signal processing portion 12 generates, based on the electrical signal from the image sensing portion 11, a video signal indicating an image (hereinafter also referred to a “shooting image”) shot by the image sensing portion 11. The image sensing portion 11 sequentially shoots images at a predetermined frame rate, and thereby obtains shooting images one after another. A shooting image indicated by a video signal obtained in one frame period (for example, 1/60 second) which is the reciprocal of the frame rate is also referred to as a frame or a frame image.

The microphone portion 13 is formed with a plurality of microphones that are arranged in different positions on the enclosure of the digital camera 1. In the present embodiment, as shown in FIG. 4, the microphone portion 13 is assumed to be formed with nondirectional microphones 13A and 13B. The microphones 13A and 13B individually convert an ambient sound around the digital camera 1 (specifically, an ambient sound around the microphone itself) into an analog sound signal. The sound signal processing portion 14 performs sound signal processing including conversion processing that converts the sound signals from the microphones 13A and 13B into digital signals, and outputs the sound signals that have been subjected to the sound signal processing. For convenience, the center of the microphones 13A and 13B (specifically, for example, an intermediate point between the center of the diaphragm of the microphone 13A and the center of the diaphragm of the microphone 13B) is referred to as a microphone origin.

The main control portion 15 includes a CPU (central processing unit), a ROM (read only memory) and a RAM (random access memory) and the like, and comprehensively controls the operations of portions of the digital camera 1. The communication portion 16 wirelessly exchanges, under control of the main control portion 15, necessary information with an external device.

In the educational system of FIG. 1, the communication portion 16 communicates with the PC 2. The PC 2 has a wireless communication function; arbitrary information transmitted by the communication portion 16 is transmitted to the PC 2. The communication between the digital camera 1 and the PC 2 may be performed by wire.

The PC 2 determines the content of a picture to be displayed on the screen 4, and transmits, by wire or wirelessly to the projector 3, picture information indicating the content of the picture. Thus, the picture that has been determined by the PC 2 to be displayed on the screen 4 is actually projected from the projector 3 to the screen 4 and is displayed on the screen 4. In FIG. 1, broken straight lines are obtained by imaging light projected from the projector 3 (the same is true in FIGS. 11 and 13 to 15, which will be described later). The projector 3 and the screen 4 are arranged such that the students 61 to 64 can visually recognize the content of a display on the screen 4. The projector 3 functions as a display device. The constituent components of the display device may be assumed to include the screen 4 or may be assumed to exclude the screen 4 (the same is true in the other embodiments, which will be described later).

The location at which the digital camera 1 is arranged and the direction in which the digital camera 1 is arranged are adjusted such that all the students 61 to 64 are present within the shooting range of the digital camera 1. Hence, the digital camera 1 shoots a frame image sequence with the students 61 to 64 included in the subject. For example, with the optical axis of the image sensing portion 11 pointed in the direction of the students 61 to 64, as shown in FIG. 1, the digital camera 1 is arranged on the top of the screen 4. The frame image sequence refers to a series of frames images that are arranged chronologically.

The digital camera 1 has the function of detecting a speaker among the students 61 to 64 and of extracting image data on the face portion of the speaker. FIG. 5 is a block diagram of a portion that has such a function. A speaker detection portion 21 and an extraction portion 22 can be provided in the main control portion 15 of FIG. 3.

Pieces of image data on the frame images obtained by the shooting of the image sensing portion 11 are input one after another to the speaker detection portion 21 and the extraction portion 22. The image data refers to one type of video signal that is expressed by digital values. The speaker detection portion 21 can perform face detection processing that extracts, based on the image data on the frame image, from the entire image region of the frame image, an image region (part of the entire image region) where image data on the face of a person is present, as a face region. By performing the face detection processing, the position and the size of the face on the frame image and an image space are detected on an individual face basis. The image space refers to a two-dimensional coordinate space where an arbitrary two-dimensional image such as the frame image is arranged. In actuality, for example, when the face region is a rectangular region, the center position of the face region and the size of the face region in horizontal and vertical directions on the frame image and the image space are detected as the position and the size of the face. In the following description, the center position of the face region is simply referred to as the position of the face.

The speaker detection portion 21 detects, based on the image data on the frame image, as a speaker, a student who is actually producing sound or a student who is about to speak among the students 61 to 64, and generates speaker information for identifying the position and the size of the face region of the speaker on the image space. As the method of detecting the speaker, various detection methods can be utilized. A plurality of detection methods will be described below as examples.

For example, as shown in FIG. 6, when a remark style in which a speaker stands up from the chair and then speaks is employed at an educational site, it is possible to detect the speaker from the position of each face or changes in position on the image space. More specifically, the face detection processing is performed on each frame image, and thus the positions of the faces of the students 61 to 64 on each frame image are monitored. Then, if the position of a certain noted face moves a predetermined distance or more in a direction in which the face moves away from the corresponding desk, the student who has the noted face is determined to be the speaker, and the position and the size of the face region on the noted face are included in the speaker information.

For example, the speaker may also be detected by deriving, based on the image data on the frame image sequence, an optical flow between frame images adjacent in time and by detecting, based on the optical flow, a specific action corresponding to the speaker.

The specific action refers to, for example, an action of standing up from the chair or an action of moving a mouth to speak.

Specifically, for example, when the optical flow indicating that the face region of the student 61 moves in a direction in which it moves away from the desk of the student 61 can be obtained, the student 61 can be detected as the speaker (the same is true in the case where the student 62 or another is the speaker).

Alternatively, for example, when the amount of movement of a mouth neighboring portion within the face region of the student 61 is calculated, if the amount of movement is greater than the reference amount of movement, the student 61 can also be detected as the speaker (the same is true in the case where the student 62 or another is the speaker). The optical flow of the mouth neighboring portion within the face region of the student 61 is a batch of motion vectors indicating the orientation and the size of movements of individual portions of the mouth neighboring portion. The average value of the sizes of these motion vectors can be calculated as the amount of movement of the mouth neighboring portion. When the student 61 is detected as the speaker, the position and the size of the face region of the student 61 are included in the speaker information (the same is true in the case where the student 62 or another is the speaker).

Alternatively, for example, the speaker may be detected by utilizing the sound signal obtained by using the microphone portion 13. Specifically, for example, in which direction the main components of output sound signals of the microphones 13A and 13B come to the microphone origin (see FIG. 4) is determined based on the phase difference between the output sound signals of the microphones 13A and 13B. The direction obtained by the determination is referred to as a sound incoming direction. As shown in FIG. 7A, the sound incoming direction is a direction between the microphone origin and the speaker. The main components of the output sound signals of the microphones 13A and 13B can be regarded as the sound of the speaker.

As a method of determining the sound incoming direction based on the phase difference between the output sound signals of a plurality of microphones, an arbitrary known method can be utilized. This determination method will be simply described with reference to FIG. 7B. As shown in FIG. 7B, the microphones 13A and 13B as the nondirectional microphones are arranged a distance Lₖ apart. A plane 13P that includes the microphones 13A and 13B and that is a boundary between the front and the back of the digital camera 1 is assumed (in FIG. 7B, which is a two-dimensional diagram perpendicular to the plane 13P, the plane 13P is represented by a line segment). In the front side, the students within the classroom into which the educational system is introduced are present. A sound source is present in front of the plane 13P; an angle between each straight line connecting the sound source to the microphones 13A and 13B and the plane 13P is assumed to be θ (where 0°<θ<90°). The sound source is assumed to be closer to the microphone 13B than to the microphone 13A. In this case, the distance from the sound source to the microphone 13A is longer than the distance from the sound source to the microphone 13B by a distance Lₖ cos θ. Hence, when the speed of the sound is assumed to be Vₖ, the sound emitted from the sound source reaches the microphone 13B, and then reaches the microphone 13A a time corresponding to “Lₖ cos θ/Vₖ” behind. Since this time difference “Lₖ cos θ/Vₖ” appears as the phase difference between the output sound signals of the microphones 13A and 13B, the phase difference (that is, Lₖ cos θ/Vₖ) between the output sound signals of the microphones 13A and 13B is determined, and thus it is possible to determine the sound incoming direction (that is, the value of θ) of the sound source, which is the speaker. As is obvious from the above description, the angle θ indicates the direction in which the sound from the speaker comes with respect to the positions where the microphones 13A and 13B are arranged.

On the other hand, based on distances on an actual space between the positions of the students 61 to 64 and the position of the digital camera 1 (the microphone origin), the focal length of the image sensing portion 11 and the like, the position of the speaker (the student 61, 62, 63 or 64) on the image space is previously made correspond to the sound incoming direction. Specifically, the above correspondence is previously made such that, when the sound incoming direction is determined, in which image region of the entire image region on the frame image the image data on the face of the speaker is present is identified. Thus, it is possible to detect, from the result of the determination of the sound incoming direction and the result of the face detection processing, the position of the face of the speaker on the frame image. When the result of the determination of the sound incoming direction reveals that the face region of the speaker is present within a specific image region on the frame image, if the face region of the student 61 is present within the specific image region, the student 61 is detected as the speaker, and the position and the size of the face region of the student 61 are included in the speaker information (the same is true in the case where the student 62 or another is the speaker).

Furthermore, for example, the speaker may be detected based on the sound signal of a sound that is produced by the teacher of the students 61 to 64 and that calls on any of the students. In this case, the called names (names or nicknames) of the students 61 to 64 are previously registered as called name data in the speaker detection portion 21, and the speaker detection portion 21 is formed such that sound recognition processing for converting, based on the sound signal, sound included in the sound signal into character data can be performed by the speaker detection portion 21. When the character data obtained by performing the sound recognition processing on the output sound signal of the microphone 13A or 13B agrees with the called name data on the student 61 or when the character data includes the called name data on the student 61, the student 61 can be detected as the speaker (the same is true in the case where the student 62 or another is the speaker). Here, if in which image region of the entire image region on the frame image the face region of the student 61 is present is previously determined, when the student 61 is detected as the speaker by the sound recognition processing, it is possible to determine, from the result of the face detection processing, the position and the size of the face that need to be included in the speaker information (the same is true in the case where the student 62 or another is the speaker). When the face images of the students 61 to 64 are previously stored as registered face images in the speaker detection portion 21, if the student 61 is detected as the speaker by the sound recognition processing, by checking the image within each of the face regions extracted from the frame image against the registered face image of the student 61, which one of the face regions extracted from the frame image is the face region of the student 61 may be determined (the same is true in the case where the student 62 or another is the speaker).

Although, as described above, the speaker can be detected by various methods based on the image data and/or the sound signal, since the style in which the speaker speaks (for example, the speaker speaks while sitting down or speaks while standing up) and the style in which the teacher calls on the student are varied depending on educational sites, it is preferable to detect the speaker by simultaneously using a plurality of methods among the detection methods described above so that the speaker can be accurately detected under any conditions.

The extraction portion 22 of FIG. 5 extracts, based on the speaker information specifying the position and the size of the face region of the speaker, the image data within the face region of the speaker from the image data on each frame image, and outputs the extracted image data as speaker image data. The image 60 of FIG. 8 shows an example of a frame image that is shot after the detection of the speaker. For ease of illustration, FIG. 8 shows only the faces of the students 61 to 64 (the illustration of their bodies and the like is omitted). In FIG. 8, broken-line rectangular regions 61_{F} to 64_{F} are respectively the face regions of the students 61 to 64 on the frame image 60. If the speaker is the student 61, when the image data on the frame image 60 is input, the extraction portion 22 extracts, as the speaker image data, image data on the face region 61_{F} from the image data on the frame image 60 and outputs it. Not only the image data on the face region of the speaker but also image data on the shoulder portion and the upper body portion of the speaker may also be included in the speaker image data.

When the speaker image data is output from the extraction portion 22, the main control portion 15 transmits the speaker image data to the PC 2 through the communication portion 16. In the PC 2, image data on an original image 70 as shown in FIG. 9A is previously stored. In the original image 70, information (such as formulas or English sentences) for learning is included. When the speaker image data is not output from the extraction portion 22, the PC 2 feeds picture information to the projector 3 such that the picture of the original image 70 itself is displayed on the screen 4. On the other hand, when the speaker image data is output from the extraction portion 22, the PC 2 generates processing image 71 as shown in FIG. 9B from the original image 70 and the speaker image data, and the PC 2 feeds the picture information to the projector 3 such the picture of the processing image 71 is displayed on the screen 4. The processing image 71 is an image that is obtained by superimposing an image 72 within the face region based on the speaker image data on a predetermined position on the original image 70. The predetermined position where the image 72 is arranged may be a predetermined fixed position or may be changed according to the content of the original image 70. For example, a flat portion (portion where the information for study is not included) of the original image 70 in which only a slight change in density is produced may be detected, and the image 72 may be arranged in the flat portion.

After the speaker is identified, the extraction portion 22 of FIG. 5 tracks, based on the image data on the frame image sequence, the position of the face region of the speaker, on the frame image sequence, and successively extract, as the speaker image data, pieces of image data within the face region of the speaker on the latest frame image. The image 72 on the processing image 71 is updated based on the successively extracted pieces of speaker image data, and thus the face image of the speaker turns into a moving image on the screen 4.

The sound signal processing portion 14 may perform sound source extraction processing that extracts only the sound signal of the sound of the speaker. In the sound source extraction processing, the sound incoming direction is detected by the method described above, thereafter directivity control for enhancing the directivity in the sound incoming direction is performed to extract only the sound signal of the sound of the speaker from the output sound signals of the microphones 13A and 13B and the extracted sound signal is generated as a speaker sound signal. In actuality, the phase difference between the output sound signals of the microphones 13A and 13B is adjusted, and thus the signal component of the sound which has come in the sound incoming direction, among the output sound signals of the microphones 13A and 13B, is enhanced, and thereafter a monophonic sound signal that is the enhanced sound signal is generated as the speaker sound signal. Consequently, in the speaker sound signal, the directivity in the sound incoming direction is greater than those in the other directions. As a directivity control method, various methods have already been proposed, and the sound signal processing portion 14 uses any of directivity control methods (for example, the methods disclosed in JP-A-2000-81900 and JP-A-10-313497) including known methods, and can thereby generate the speaker sound signal.

The digital camera 1 can transmit the obtained speaker sound signal to the PC 2. The speaker sound signal can be output from a loudspeaker (unillustrated) arranged within the classroom where the students 61 to 64 are present or can be recorded in a recording medium (unillustrated) provided in the digital camera 1 or the PC 2. The signal intensity of the speaker sound signal may be measured in the PC 2, and then an indicator corresponding to the measured signal intensity may be superimposed on the processing image 71 of FIG. 9B. The signal intensity can also be measured on the side of the digital camera 1. FIG. 10 shows an image 74 that is obtained by superimposing the indicator on the processing image 71. The state of the indicator 75 on the image 74 is changed according to the signal intensity of the speaker sound signal, and how the state is changed reflects the content of the display on the screen 4. The speaker checks the state of the indicator 75, and can thereby recognize the level of voice produced by himself, with the result that the speaker can have a motivation to speak clearly.

As described in the present embodiment, the face image of the speaker is displayed on the screen 4, and thus all the students can listen to his remarks while watching the face of the speaker. The communication between the students with the face of the speaker being watched is performed, and thus the willingness of the students to join the class (willingness to study) and the realism of the class are enhanced, and the advantages of group learning (such as the effect of enhancing the willingness to study due to competitiveness) can be utilized more satisfactorily. Moreover, the students other than the speaker listen to his remarks while watching the face of the speaker, and thus they can grasp the intension of the speaker that cannot be expressed with words. In other words, information (for example, the degree of confidence of remarks that can be grasped from his facial expression) other than words can also be obtained, with the result that the efficiency of learning by listening to the remarks is enhanced.

Although the basic operation and configuration of the educational system according to the present embodiment have been described, the following application examples can also be applied to the educational system.

For example, the number of times that each of the students 61 to 64 speaks as a speaker may be counted, for each student, based on the result of detection by the speaker detection portion 21, and then the counted number of times may be recorded in a memory or the like of the PC 2. Here, for each student, a length of time for which the student speaks may also be recorded in the memory or the like of the PC 2. The teacher can utilize such recorded data as support data for evaluation of the willingness of the students to study and the like.

When a plurality of students among the students 61 to 64 raise their hands in order to become a speaker, the teacher generally calls on, as the speaker, one of the students raising their hands. However, the students raising their hands may be automatically detected on the side of the digital camera 1 based on the optical flow or the like, and then the digital camera 1 may utilize random numbers or the like to call on, as the speaker, one of the students raising their hands. Even in this case, image data on the face region of the student who is called on by the digital camera 1 as the speaker is extracted as the speaker image data, and the face image of the speaker is displayed on the screen 4. In the method in which a teacher calls on a student as the speaker, a subjective element is inevitably produced, and thus students are unequally called on as the speaker or a feeling of inequality is generated that, although inequality is not actually produced, inequality may be being produced. Since the unequalness and the feeling of inequality described above are factors that inhibit the willingness of the students to study, it is preferable to eliminate those. The speaker calling-on method described above and using the digital camera 1 facilitates the elimination of the inhibiting factors.

Picture information transmitted from the PC 2 to the projector 3 and sound information (including the speaker sound signal) based on the sound signal obtained by the microphone portion 13 may be distributed to satellite classrooms where students other than the students 61 to 64 take classes. Specifically, for example, the picture information transmitted from the PC 2 to the projector 3 and the sound information based on the sound signal obtained by the microphone portion 13 are transmitted by wire or wireless from the PC 2 to an information terminal other than the PC 2. The information terminal feeds the picture information to a projector arranged in a satellite classroom, and thereby displays, on a screen arranged in the satellite classroom, the same picture as the screen 4. The information terminal also feeds the sound information to a loudspeaker arranged in the satellite classroom. In this way, the students who take a class in the satellite classroom can not only watch the same picture as the screen 4 but also listen to the same sound as in the classroom where the screen 4 is arranged.

Although, in the example described above, the speaker image data extracted by the extraction portion 22 is temporarily fed to the PC 2, the speaker image data may be fed from the extraction portion 22 within the digital camera 1 directly to the projector 3, and thus, based on the original image 70 (see FIG. 9A) from the PC 2 and the speaker image data from the extraction portion 22, processing that generates the processing image 71 (see FIG. 9B) may be performed within the projector 3.

Although, in the example shown in FIG. 1, the digital camera 1 and the projector 3 are individually placed in separate enclosures, the digital camera 1 and the projector 3 can be placed in the same enclosure (in other words, the digital camera 1 and the projector 3 can be integral with each other). In this case, a device in which the digital camera 1 and the projector 3 are integral with each other may be arranged on the top of the screen 4. If the digital camera 1 and the projector 3 are integral with each other, it is unnecessary to perform wireless communication or the like when the speaker image data is fed to the projector 3. When, as the projector 3, an ultra-short focus projector is used that can project a picture of a few tens of inches simply by being arranged about a few centimeters apart from the screen 4, the integration described above is easily achieved.

Although a description has been given of the example where the speaker detection portion 21 and the extraction portion 22 are provided in the digital camera 1, the speaker detection portion 21 and the extraction portion 22 may be included in an arbitrary constituent element of the educational system (presentation system) other than the digital camera 1.

In other words, for example, any one or both of the speaker detection portion 21 and the extraction portion 22 may be provided in the PC 2. When the speaker detection portion 21 and the extraction portion 22 are provided in the PC 2, the image data on the frame image obtained by the shooting of the image sensing portion 11 is preferably fed through the communication portion 16 to the PC 2 without being processed. By providing the extraction portion 22 in the PC 2, it is possible to highly flexibly perform settings on the extraction. For example, processing that registers the face images of students or the like can be performed on an application that runs on the PC 2. Any one or both of the speaker detection portion 21 and the extraction portion 22 can also be provided in the projector 3.

A portion composed of the microphone portion 13 and the sound signal processing portion 14 functions as a sound signal generation portion that generates the speaker sound signal, all or part of the function of the sound signal generation portion may be performed not by the digital camera 1 but by the PC 2 or the projector 3.

Although, in the present embodiment, the number of digital cameras that shoot the scenery of the inside of the classroom is assumed to be one, a plurality of digital cameras may be used. By coordinating a plurality of digital cameras, pictures seen in many directions can be displayed on the screen.

### Second Embodiment

A second embodiment of the present invention will be described. FIG. 11 is a diagram showing the overall configuration of an educational system (presentation system) according to the second embodiment, along with users of the educational system. The educational system of the second embodiment can be employed at an educational site of students in an arbitrary age bracket, in particular, for example, it is suitably employed at educational sites of elementary school students, junior high school students and high school students. Persons 160_{A} to 160_{C} shown in FIG. 11 are students at an educational site. Although, in the present embodiment, the number of students is assumed to be three, the number of students is not limited as long as it is two or more. A desk is arranged in front of each of the students 160_{A} to 160_{C}, and information terminals 101_{A} to 101_{C} are allocated to the students 160_{A} to 160_{C}, respectively. The educational system of FIG. 11 is configured to include a PC 102 that is an information terminal for the teacher, a projector 103, a screen 104 and the information terminals 101_{A} to 101_{C} for the students.

FIG. 12 is a schematic internal block diagram of the information terminal 101_{A}. The information terminal 101_{A} includes: a microphone 111 that collects sound produced by the student 160_{A} corresponding to the information terminal 101_{A} and that converts the sound into a sound signal; a sound signal processing portion 112 that performs necessary signal processing on the sound signal from the microphone 111; a communication portion 113 that performs communication with the PC 102 wirelessly or by wire; and a display portion 114 that is formed with a liquid crystal display panel or the like.

Based on the waveform of the sound signal from the microphone 111, the sound signal processing portion 112 can perform sound recognition processing that converts sound included in the sound signal into character data. The communication portion 113 can transmit, to the PC 102, arbitrary information including the character data obtained by the sound signal processing portion 112. It is possible to display an arbitrary picture on the display portion 114, and also display, on the display portion 114, a picture based on a video signal fed from the PC 102 to the communication portion 113.

The configurations of the information terminals 101_{B} and 101_{C} are the same as that of the information terminal 101_{A}. Naturally, the microphones 111 of the information terminals 101_{B} and 101_{c} collect sounds produced by the students 160_{B} and 160_{C}, respectively, and convert them into sound signals. The students 160_{A} to 160_{C} can respectively and visually recognize the content of the display on the display portions 114 of the information terminals 101_{A} to 101_{C}. When the information terminals 101_{A} to 101_{C} use the communication portions 113 to communicate with the PC 102, they transmits, to the PC 102, a unique 1D number allocated to each of the information terminals. Thus, the PC 102 can recognize from which information terminal the received information is transmitted. It is possible to omit the display portion 114 from each of the information terminals 101_{A} to 101_{C}.

The PC 102 determines the content of a picture to be displayed on the screen 104, and transmits, wirelessly or by wire, to the projector 103, picture information indicating the content of the picture. Thus, the picture that the PC 102 has determined to be displayed on the screen 104 is actually projected from the projector 103 to the screen 104 and is displayed on the screen 104. The projector 103 and the screen 104 are arranged such that the students 160_{A} to 160_{C} can visually recognize the content of the display on the screen 104. The PC 102 also functions as a display control portion for the display portion 114 and the screen 104, and can freely change, through the communication portion 113, the content of the display on the display portion 114 and can also freely change, through the projector 103, the content of the display on the screen 104.

In the PC 102, a specific program is installed which is formed such that, when specific character data is transmitted from the information terminals 101_{A} to 101_{C}, a specific operation is performed. The administrator (for example, the teacher) of the educational system can freely customize the operation of the specific program according to the content of a class. A few examples of the operation of the specific program will be sequentially described below.

In the first operation example, the specific program is assumed to be a social learning program, and, when this social learning program is executed, the picture of a map of Japan without the names of the prefectures is first displayed on the screen 104 and/or each display portion 114. For example, when the teacher wants to give the students such a question that the students answer the location of “Hokkaido” on the map of Japan, the teacher operates the PC 102 and thereby specifies Hokkaido on the map of Japan. When this specification has been performed, the PC 102 blinks the picture portion of Hokkaido on the map of Japan on the screen 104 and/or each display portion 114. Each student produces the sound of the name of the prefecture in the blinking portion toward the microphone 111 of the information terminal corresponding to himself. Here, when character data indicating that the name of the prefecture sounded by the student 160_{A} is “Hokkaido” is transmitted from the information terminal 101_{A} to the PC 102, the social learning program controls the content of the display on the display portion 114 of the information terminal 101_{A} and/or the screen 104 such that the characters of “Hokkaido” are displayed in the portion of the display of Hokkaido on the map of Japan on the display portion 114 of the information terminal 101_{A} and/or the screen 104. The control on the content of the display described above is not performed if the name of the prefecture sounded by the student 160_{A} is different from “Hokkaido”; in this case, another display is produced. The control on the display corresponding to the content of the sound of the student 160_{B} or 160_{C} is also the same as that on the student 160_{A}.

In the second operation example, the specific program is assumed to be an arithmetic learning program, and, when this arithmetic learning program is executed, the picture of a multiplication table with each section blank is displayed on the screen 104 and/or each display portion 114. For example, when the teacher wants to give the students such a question that the students answer the product of 4 and 5, the teacher operates the PC 102 and thereby specifies the section of “4×5” on the multiplication table. When this specification has been performed, the PC 102 blinks the picture portion of the section of “4×5” on the multiplication table on the screen 104 and/or each display portion 114. Each student produces the sound of the answer for the blinking portion (specifically, the value of the product of 4 and 5) toward the microphone 111 of the information terminal corresponding to himself. Here, when character data indicating that the value sounded by the student 160_{A} is “20” is transmitted from the information terminal 101_{A} to the PC 102, the arithmetic learning program controls the content of the display on the display portion 114 of the information terminal 101_{A} and/or the screen 104 such that the value “20” is displayed in the portion of the display of the section of “4×5” on the display portion 114 of the information terminal 101_{A} and/or the screen 104. The control on the content of the display described above is not performed if the value sounded by the student 160_{A} is different from “20”; in this case, another display is produced. The control on the display corresponding to the content of the sound of the student 160_{B} or 160_{C} is also the same as that on the student 160_{A}.

In the third operation example, the specific program is assumed to be an English learning program, and, when this English learning program is executed, the word of a verb of English (such as “take” or “eat”) is first displayed on the screen 104 and/or each display portion 114. For example, when the teacher wants to give the students such a question that the students answer the past tense of the word “take” of the verb of English, the teacher operates the PC 102 and thereby specifies the word “take.” When this specification has been performed, the PC 102 blinks the picture portion of the word “take” displayed on the screen 104 and/or each display portion 114. Each student produces the sound of the past tense (that is, “took”) of the blinking word “take” toward the microphone 111 of the information terminal corresponding to himself. Here, when character data indicating that the word sounded by the student 160_{A} is “took” is transmitted from the information terminal 101_{A} to the PC 102, the English learning program controls the content of the display on the display portion 114 of the information terminal 101_{A} and/or the screen 104 such that the word “take” displayed on the display portion 114 of the information terminal 101_{A} and/or the screen 104 is changed to the word “took.” The control on the content of the display described above is not performed if the word sounded by the student 160_{A} is different from the word “took”; in this case, another display is produced. The control on the display corresponding to the content of the sound of the student 160_{B} or 160_{C} is also the same as that on the student 160_{A}.

Although a method of using a pointing device such as a pen tablet to make a student answer a question can be considered, as described in the present embodiment, the student is made to produce sound to answer the question and hence the result of the answer is reflected on a display screen, and thus the five senses of the student is stimulated more. Consequently, it is possible to expect the enhancement of the willingness of students to study and their power of memory.

Although, in the example of the above configuration, the sound recognition processing is performed on the side of the information terminals for the students, the sound recognition processing may be performed in an arbitrarily device other than the information terminals for the students. The sound recognition processing may be performed in the PC 102 or the projector 103. Preferably, when the sound recognition processing is performed in the PC 102 or the projector 103, the sound signal obtained from the microphone 111 of each of the information terminals is transmitted through the communication portion 113 to the PC 102 or the projector 103, and, for each of the information terminals, the PC 102 or the projector 103 converts sound included in the sound signal into character data based on the waveform of the transmitted sound signal.

A digital camera that shoots the state of each student or the picture displayed on the screen 104 may be provided in the projector 103, and the result of the shooting by the digital camera may be utilized in any form at an educational site. For example, each student is placed within the shooting range of the digital camera provided in the projector 103, and the method described in the first embodiment is employed. Thus, the image of the speaker may be displayed on the screen 104 (the same is true in the other embodiments, which will be described later).

### Third Embodiment

A third embodiment of the present invention will be described. FIG. 13 is a diagram showing the overall configuration of an educational system according to the third embodiment, along with users of the educational system. The educational system of the third embodiment can be employed at an educational site of students in an arbitrary age bracket, in particular, for example, it is suitably employed at educational sites of elementary school students, junior high school students and high school students. Persons 260_{A} to 260_{C} shown in FIG. 13 are students at an educational site. Although, in the present embodiment, the number of students is assumed to be three, the number of students is not limited as long as it is two or more. A desk is arranged in front of each of the students 260_{A} to 260_{C}, and information terminals 201_{A} to 201_{C} are allocated to the students 260_{A} to 260_{C}, respectively. The educational system of FIG. 13 is configured to include a projector 203, a screen 204 and the information terminals 201_{A} to 201_{C}.

The projector 203 projects a desired picture on the screen 204. The projector 203 and the screen 204 are arranged such that the students 260_{A} to 260_{C} can visually recognize the content of the display on the screen 204.

Communication portions are incorporated into each of the information terminals and the projector 203 such that wireless communication can be performed between each of the information terminals 201_{A} to 201_{C} and the projector 203. When the information terminals 201_{A} to 201_{C} communicate with the projector 203, they transmit, to the projector 203, a unique ID number allocated to each of the information terminals. Thus, the projector 203 can recognize from which information terminal the received information is transmitted.

Each of the information terminals 201_{A} to 201_{C} includes a pointing device such as a keyboard, a pen tablet or a touch panel; the students 260_{A} to 260_{C} respectively operate the pointing devices of the information terminals 201_{A} to 201_{C}, and thereby can transmit arbitrary information (such as an answer to a question) to the projector 203.

In the example of FIG. 13, English learning is performed, and the students 260_{A} to 260_{C} input, with the pointing devices of the information terminals 201_{A} to 201_{C}, answers to the question asked by the teacher. The answers of the students 260_{A} to 260_{C} are transmitted from the information terminals 201_{A} to 201_{C} to the projector 203; the projector 203 projects characters indicating the answers of the students 260_{A} to 260_{C} and the like on the screen 204. Here, the content of the display on the screen 204 is controlled such that which answer on the screen 204 is made by which student is understood. For example, on the screen 204, the called name (the name, the nickname, the identification number or the like) of the student 260_{A} is displayed in the vicinity of the answer of the student 260_{A} (the same is true of the student 260_{B} and the student 260_{C}).

The teacher uses a laser pointer and thereby can specify an arbitrary answer on the screen 204. A plurality of detectors for detecting whether or not to receive light produced by the laser pointer are arranged in a matrix on the display surface of the screen 204, and thus it is possible to detect, on the screen 204, to which part of the screen 204 the light produced by the laser pointer is applied. The projector 203 can change, based on the result of the detection, the content of the display on the screen 204. With a man-machine interface (for example, a switch connected to the projector 203) other than a laser pointer, the answer on the screen 204 may be specified.

For example, when a display portion on the screen 204 where the answer of the student 260_{A} is displayed is specified by the laser pointer, as shown in FIG. 14, the display size of the answer of the student 260_{A} on the screen 204 is enlarged as compared with the display size before the specification is performed, (alternatively, for example, the display portion where the answer of the student 260_{A} is displayed may he made to blink). It is assumed that, thereafter, at the educational site, for example, the teacher and the student 260_{A} exchange questions and answers.

In the educational system of the present embodiment, the following form of use is also assumed. The students 260_{A} to 260_{C} respectively answer a question asked by the teacher with the pointing devices of the information terminals 201_{A} to 201_{C}. For example, the pointing devices of the information terminals 201_{A} to 201_{C} are formed with pen tablets (liquid crystal pen tablets) having a display device, and the students 260_{A} to 260_{C} use special pens to write their answers on the corresponding pent tablets.

The teacher uses an arbitrary man-machine interface (such as a PC, a pointing device or a switch), and can thereby specify any one of the information terminals 201_{A} to 201_{C}, and the result of the specification is transmitted to the projector 203. If the information terminal 201_{A} is specified, the projector 203 performs transmission requirement on the information terminal 201_{A}, and, according to the transmission requirement, the information terminal 201_{A} transmits, to the projector 203, information corresponding to the content of the information written on the pen tablet of the information terminal 201_{A}. The projector 203 displays, on the screen 204, the picture corresponding to the transmitted information. Simply, for example, the content of the information written on the pen tablet of the information terminal 201_{A} can be displayed on the screen 204 without being processed. The same is true in the case where the information terminal 201_{B} or 201_{C} is specified.

Although, in the configuration shown in FIG. 13, a PC (personal computer) is not incorporated into the educational system, as in the second embodiment, the PC may be incorporated, as the information terminal for the teacher, into the educational system of the present embodiment. When the PC is incorporated, the PC communicates with the information terminal 201_{A} to 201_{C} to produce picture information corresponding to the answer of each student, transmits the picture information to the projector 203 wirelessly or by wire and can thereby display the picture corresponding to the picture information on the screen 204.

### Fourth Embodiment

A fourth embodiment of the present invention will be described. FIG. 15 is a diagram showing the overall configuration of an educational system according to the fourth embodiment, along with users of the educational system. The educational system of the fourth embodiment can be employed at an educational site of students in an arbitrary age bracket, in particular, for example, it is suitably employed at educational sites of elementary school students and junior high school students. Persons 360_{A} to 360_{C} shown in FIG. 15 are students at an educational site. Although, in the present embodiment, the number of students is assumed to be three, the number of students is not limited as long as it is two or more. A desk is arranged in front of each of the students 360_{A} to 360_{C}, and information terminals 301_{A} to 301_{C} are allocated to the students 360_{A} to 360_{C}, respectively. An information terminal 302 for the teacher is allocated to the teacher of the educational site.

The educational system of FIG. 15 is configured to include the information terminals 301_{A} to 301_{C}, the information terminal 302, a projector 303 and a screen 304. The projector 303 incorporates a digital camera 331; the digital camera 331 shoots, as necessary, the content of the display on the screen 304. Wireless communication can be performed between the information terminals 301_{A} to 301_{C} and the information terminal 302; wireless communication can be performed between the projector 303 and the information terminal 302. When the information terminals 301_{A} to 301_{C} communicate with the information terminal 302, they transmit, to the information terminal 302, a unique ID number allocated to each of the information terminals 301_{A} to 301_{C}. Thus, the information terminal 302 can recognize from which information terminal (301_{A}, 301_{B} or 301_{C}) the received information is transmitted.

The information terminal 302 for the teacher determines the content of a picture to be displayed on the screen 304, and wirelessly transmits, to the projector 303, picture information indicating the content of the picture. Thus, the picture that the information terminal 302 has determined to be displayed on the screen 304 is actually projected from the projector 303 to the screen 304 and is displayed on the screen 304. The projector 303 and the screen 304 are arranged such that the students 360_{A} to 360_{C} can visually recognize the content of the display on the screen 304.

The information terminal 302 is a thin PC, for example; it operates using a secondary battery as a drive source. The information terminal 302 includes: a pointing device that is composed of a touch panel and a touch pen; and a removable camera that is a digital camera which is removable with respect to the enclosure of the information terminal 302. Furthermore, the information terminal 302 may include a laser pointer and the like. In the information terminal 302, the touch panel functions as a display portion.

The information terminal 301_{A} for the student includes: a pointing device that is composed of a touch panel and a touch pen; and a removable camera that is a digital camera which is removable with respect to the enclosure of the information terminal 301_{A}. The information terminal 301_{A} operates using a secondary battery as a drive source. In the information terminal 301_{A}, the touch panel functions as a display portion. The information terminals 301_{B} and 301_{C} are the same as the information terminal 301_{A}.

The information terminal 302 can receive material contents in which the content of learning is described, either through a communication network such as the Internet or through a recording medium. The teacher operates the pointing device of the information terminal 302, and thereby selects a material content desired to be displayed from one or a plurality of received material contents. When this selection has been performed, the picture of the selected material content is displayed on the touch panel of the information terminal 302. On the other hand, the information terminal 302 transmits picture information on the selected material content to the projector 303 or the information terminals 301_{A} to 301_{C}, and can thereby display the picture of the selected material content on the screen 304 or the touch panels of the information terminals 301_{A} to 301_{C}. By shooting, with the removable camera of the information terminal 302, an arbitrary material, a text, the work of a student or the like and then transmitting image data on the shooting image from the information terminal 302 to the projector 303 or the information terminals 301_{A} to 301_{C}, it is also possible to display the shooting image on the screen 304 or the touch panels of the information terminals 301_{A} to 301_{C}.

When a question for learning (for example, an arithmetic question) is displayed on the screen 304 or the touch panels of the information terminals 301_{A} to 301_{C}, the students 360_{A} to 360_{C} use the pointing devices of the information terminals 301_{A} to 301_{C} to answer the question. Specifically, the students 360_{A} to 360_{C} write their answers on the touch panels of the information terminals 301_{A} to 301_{C} or select, with the touch pen, a choice that is considered to be a correct answer when the question is a multiple choice question. The answers input by the students 360_{A} to 360_{C} to the information terminals 301_{A} to 301_{C} are respectively transmitted as answers A, B and C to the information terminal 302 for the teacher.

When the teacher uses the pointing device of the information terminal 302 to select an answer check mode that is one of the operation modes of the information terminal 302, the information terminal 302 operates an answer check mode program.

The answer cheek mode program first produces a template image corresponding to the state of arrangement of the information terminals for the students within the classroom, and transmits, to the projector 303, picture information for displaying the template image on the screen 304. Thus, for example, the content of the display on the screen 304 is that as shown in FIG. 16. Here, the called names of the students 360_{A} to 360_{C} on the answer check mode program are assumed to be students A, B and C, respectively. Then, as in the arrangement of the students 360_{A} to 360_{C} within the classroom, a rectangular frame having student A written thereon, a rectangular frame having student B written thereon and a rectangular frame having student C written thereon are arranged and displayed in the template image. If (5×4) students are two-dimensionally arranged though this assumption is different from the assumption of the present embodiment, a template image including the (5×4) rectangular frames having the corresponding called names written thereon is generated, with the result that the content of the display on the screen 304 is that as shown in FIG. 17.

While the answer check mode program is being operated, when the teacher uses the pointing device of the information terminal 302 to select student A (that is, the student 360_{A}), the answer check mode program produces picture information for displaying answer A on the screen 304, and transmits the picture information to the projector 303. Thus, the same content as that written on the touch panel of the information terminal 301_{A} or the same content as that of the display on the touch panel of the information terminal 301_{A} is displayed on the screen 304.

When the teacher uses the pointing device of the information terminal 302 to select student A (that is, the student 360_{A}), by wirelessly transmitting picture information from the information terminal 301_{A} directly to the projector 303, the same content as that written on the touch panel of the information terminal 301_{A} or the same content as that of the display on the touch panel of the information terminal 301_{A} may be displayed on the screen 304. The teacher can also select student A not with the pointing device but with a laser pointer included in the information terminal 302. The laser pointer can specify an arbitrary position on the screen 304; the screen 304 detects the specified position by the method described in the third embodiment. Based on the specified position transmitted from the screen 304 through the projector 303, the answer check mode program can recognize which student is selected. Although the operation performed when student A (that is, the student 360_{A}) is selected has been described, the same is true in the case where the student B or C (that is, the student 360_{A} or 360_{B}) is selected.

Depending on the material content, the student uses a special screen pen to input or display an answer or the like directly onto the screen 304. The path of the special screen pen that moves on the screen 304 is displayed on the screen 304. While the path is being displayed, when the teacher performs a predetermined recording operation on the information terminal 302, the content of the operation is transmitted to the projector 303, and the digital camera 331 shoots the display screen of the screen 304. Under control of the information terminal 302, an image obtained by this shooting is transferred to the information terminal 302 and the information terminals 301_{A} to 301_{C}, and the image can also be either displayed on the information terminal 302 and the touch panels of the information terminals 301_{A} to 301_{C} or recorded in a recording medium in the information terminal 302.

The removable cameras incorporated into the information terminals 301_{A} to 301_{C} for the students can shoot the faces of the corresponding student 360_{A} to 360_{C}. The information terminals 301_{A} to 301_{C} transmit image data on the shooting images of the faces of the student 360_{A} to 360_{C} either to the information terminal 302 or directly to the projector 303, and thus it is possible to display the shooting images of the faces in the vicinity of the display screen of the screen 304. In this way, even when the teacher faces the screen 304, the teacher can check the state of each student (for example, the teacher can check if the student is taking a nap).

### Fifth Embodiment

A fifth embodiment of the present invention will be described. In the fifth embodiment and the other embodiments, which will be described later, with respect to what is not particularly described, unless otherwise a contradiction arises, what has been described in the first, second, third or fourth embodiment can be applied to the fifth embodiment and the other embodiments, which will be described later. An overall diagram showing the configuration of an educational system (presentation system) according to the fifth embodiment is the same as in the first embodiment (see FIG. 1). In other words, the educational system of the fifth embodiment is configured to include the digital camera 1, the PC 2, the projector 3 and the screen 4.

In the fifth embodiment, as shown in FIG. 18, a camera drive mechanism 17 for changing the direction of the optical axis of the image sensing portion 11 is assumed to be provided in the digital camera 1. The camera drive mechanism 17 is formed with a pan head that fixes the image sensing portion 11, a motor that rotates and drives the pan head and the like. The main control portion 15 of the digital camera 1 or the PC 2 uses the camera drive mechanism 17, and can thereby change the direction of the optical axis of the image sensing portion 11. The microphones 13A and 13B of FIG. 4 are not fixed to the pan head. Hence, it is assumed that, even if the camera drive mechanism 17 is used to change the direction of the optical axis of the image sensing portion 11, the positions of the microphones 13A and 13B and the direction in which sound is collected are not affected by the change. The microphone portion 13 formed with the microphones 13A and 13B may be regarded as a microphone portion that is provided outside the digital camera 1.

In the fifth embodiment, the following classroom environment EE_{A} is assumed (see FIGS. 19A and 19B). In the classroom environment EE_{A}, within a classroom 500 into which the educational system is introduced, 16 students ST[1] to ST[16] who are persons are present, a desk is allocated to each of the students ST[1] to ST[16], a total of 16 desks are arranged such that 4 desks are arranged both vertically and horizontally (see FIG. 19B), the students ST[1] to ST[16] sit on chairs corresponding to the desks (in FIG. 19A, the desks and the chairs are not illustrated) and the projector 3 and the screen 4 are arranged within the classroom 500 such that the students ST[1] to ST[ 16] can visually recognize the content of the display on the screen 4.

As shown in FIG. 1, for example, the digital camera 1 can be arranged on the top of the screen 4. The microphones 13A and 13B individually convert an ambient sound around the digital camera 1 (specifically, an ambient sound around the microphone itself) into a sound signal, and output the obtained sound signal. The output sound signals of the microphones 13A and 13B may be either analogue signals or digital signals; as described in the first embodiment, they may be those that are converted into digital sound signals by the sound signal processing portion 14 of FIG. 3. When a student ST[i] produces sound, the ambient sound of the digital camera 1 includes the sound of the student ST[i] who is the speaker (i is an integer).

It is now assumed that the location at which the digital camera 1 is arranged, the direction in which the digital camera 1 is arranged and the angle of view of the image sensing portion 11 are set such that only part of the students ST[1] to ST[16] are simultaneously placed within the shooting range of the image sensing portion 11. When it is assumed that, between first and second timings, the direction of the optical axis of the image sensing portion 11 is changed using the camera drive mechanism 17, for example, in the first timing, only the students ST[1], ST[2] and ST[5] are placed within the shooting range of the image sensing portion 11, and, in the second timing, only the students ST[3], ST[4] and ST[8] are placed within the shooting range of the image sensing portion 11.

FIG. 20 is a block diagram of part of the educational system according to the fifth embodiment; the educational system includes portions represented by symbols 17 and 31 to 36. The portions shown in FIG. 20 are provided within any arbitrary device of the educational system; all or part thereof can also be provided in the digital camera 1 or the PC 2. For example, the speaker detection portion 31 including the sound incoming direction determination portion 32, the speaker image data generation portion 33 and the speaker sound signal generation portion 34 may be provided within the digital camera 1 whereas the control portion 35 functioning as a recording control portion and the recording medium 36 may be provided within the PC 2. In the educational system, information transmission between different arbitrary portions can be achieved by wireless communication or by communication by wire (the same is true in all other embodiments).

Based on the output sound signals of the microphones 13A and 13B, the sound incoming direction determination portion 32 determines the direction in which sound from the speaker comes with respect to the positions where the microphones 13A and 13B are arranged, that is, determines the sound incoming direction (see FIG. 7A). The method of determining the sound incoming direction based on the phase difference between the output sound signals is the same as in the first embodiment; the angle θ of the sound incoming direction is obtained by this determination (see FIG. 7B).

The speaker detection portion 31 detects the speaker based on the angle θ determined by the sound incoming direction determination portion 32. The angle between the student ST[i] and the plane 13P shown in FIG. 7B is represented by θ_{ST[i]}; θ_{ST[1]} to θ_{ST[16]} are assumed to be different from each other. Then, when the angle θ is determined, it is possible to detect which student is the speaker. When the difference of the angles between adjacent students (for example, the difference between θ_{ST[6]} and θ_{ST[7]}) is sufficiently large, it is possible to accurately detect the speaker based on only the result of the determination by the sound incoming direction determination portion 32 whereas, when the difference of the angles is small, it is possible to increase the accuracy of the detection of the speaker by further additionally using image data (the detail thereof will be described later).

The speaker detection portion 31 changes the direction of the optical axis of the image sensing portion 11 with the camera drive mechanism 17 such that the sound source corresponding to the angle θ is placed within the shooting range of the image sensing portion 11.

For example, it is assumed that the student ST[2] produces sound as the speaker with only the students ST[3], ST[4] and ST[8] placed within the shooting range of the image sensing portion 11. In this case, the sound incoming direction determination portion 32 determines, as the angle θ, the angle θ_{ST[2]} between the student ST[2] and the plane 13P, and the speaker detection portion 31 changes the direction of the optical axis of the image sensing portion 11 with the camera drive mechanism 17 such that the sound source corresponding to the angle θ (=θ_{ST[2]}), that is, the student ST[2], is placed within the shooting range of the image sensing portion 11. The expression “the student ST[i] is placed within the shooting range of the image sensing portion 11” means that at least the face of the student ST[i] is placed within the shooting range of the image sensing portion 11.

Although it is possible to determine, based on the angle θ determined by the sound incoming direction determination portion 32, which of the students ST[1], ST[2] and ST[5] is the speaker, when it is difficult to determine, only with the angle θ, which of the students ST[1], ST[2] and ST[5] is the speaker, the speaker detection portion 31 additionally uses image data and can thereby specify the speaker. Specifically, for example, in this case, based on the angle θ, the direction of the optical axis of the image sensing portion 11 is changed with the camera drive mechanism 17 such that the students ST[1], ST[2] and ST[5] are placed within the shooting range of the image sensing portion 11, and, in this state, with the image data on the frame image obtained from the image sensing portion 11, it is possible to detect which of the students ST[1], ST[2] and ST[5] is the speaker. As the method of detecting, based on the image data on the frame image, the speaker from a plurality of students, the method described in the first embodiment can be utilized.

After the detection of the speaker or in the process of the detection, the speaker detection portion 31 can perform shooting control in which to note the speaker. This shooting control also includes the control in which the direction of the optical axis of the image sensing portion 11 is changed with the camera drive mechanism 17 such that the sound source corresponding to the angle θ is placed within the shooting range of the image sensing portion 11. Furthermore, for example, the direction of the optical axis of the image sensing portion 11 may be changed with the camera drive mechanism 17 such that, among the faces of the students ST[1] to ST[16], only the face of the student who is the speaker is placed within the shooting range of the image sensing portion 11; in this case, as necessary, the angle of view of the shooting of the image sensing portion 11 may be controlled.

The frame image obtained by performing shooting with the speaker placed within the shooting range of the image sensing portion 11 is referred to as a frame image 530. An example of the frame image 530 is shown in FIG. 21. Although, in the frame image 530 of FIG. 21, only one student is shown as the speaker, not only image data on the speaker but also image data on a student other than the speaker may be present in the frame image 530. The PC 2 receives, by communication, the image data on the frame image 530 from the digital camera 1, and can display, as a picture, on the screen 4, the frame image 530 itself or an image based on the frame image 530.

The speaker detection portion 31 of FIG. 20 is made to generate the speaker information described in the first embodiment, and the extraction portion 22 shown in FIG. 5 can be provided in the speaker image data generation portion 33 of FIG. 20. Thus, the speaker image data generation portion 33 can extract the speaker image data from the image data on the frame image 530 based on the speaker information. The image indicated by the speaker image data can also be displayed as a picture on the screen 4.

Based on the result of the determination of the sound incoming direction, the speaker sound signal generation portion 34 extracts, with the same method as in the first embodiment, a sound signal component coming from the speaker from the output sound signals of the microphones 13A and 13B, and thereby generates the speaker sound signal that is a sound signal in which a sound component from the speaker is enhanced. The speaker sound signal generation portion 34 may perform the sound recognition processing described in any one of the embodiments discussed above, and may convert sound included in the speaker sound signal into character data (hereinafter referred to as speaker character data).

It is possible to record, in the recording medium 36, arbitrary data such as image data (for example, speaker image data) based on the output from the image sensing portion 11 and sound signal data (for example, data indicating the speaker sound signal) based on the output of the microphone portion 13; it is also possible to transmit the arbitrary data to an arbitrary device of the educational system; and it is also possible to reproduce the arbitrary data at an arbitrary reproduction device. The control portion 35 can control the recording, the transmission and the reproduction.

Since, even in the present embodiment, all the students can listen to the remarks of the speaker while watching the face of the speaker, the same effects as in the first embodiment can be obtained.

Several applied technologies or modified technologies that can be applied to the present embodiment will be described below as technologies α1 to α5. Unless otherwise a contradiction arises, a plurality of technologies among technologies α1 to α5 can also be combined and embodied.

[Technology α1]

Technology α1 will be described. In technology α1, the control portion 35 makes the speaker image data and the speaker sound data corresponding to the speaker sound signal relate to each other, and records them in the recording medium 36. For example, the speaker sound data is either the speaker sound signal itself or its compression signal or the speaker character data. As the method of making a plurality of pieces of data relate to each other and recording them, an arbitrary method may be used. For example, preferably, a plurality of pieces of data that need to be made to relate to each other are stored in one file, and the file is recorded in the recording medium 36. By reading, from the recording medium 36, the speaker image data in the format of a moving image and the speaker sound signal, it is also possible to reproduce the moving image of the speaker with his sound.

The control portion 35 can also measure the length of time for which the speaker speaks (hereinafter referred to as a speaking time). The speaking time is a length of time from when the speaker is detected to when predetermined conditions for completion of remarks are satisfied. For example, the conditions for completion of remarks are satisfied when the sound of the speaker is not detected for a predetermined period of time after the speaker produces sound or when the speaker who is speaking while standing from the desk sits down. The control portion 35 can make the speaker image data, the speaker sound data and speaking time data relate to each other and record them in the recording medium 36. The speaking time data is data that indicates the speaking time.

The recording with the relation of the speaker image data to the speaker sound data or the recording with the relation of the speaker image data, the speaker sound data and the speaking time data to each other can be performed on an individual speaker basis (that is, on an individual student basis). The speaker image data and the speaker sound data recorded with the relation of the speaker image data to the speaker sound data or the speaker image data, the speaker sound data and the speaking time data recorded with the relation of the speaker image data, the speaker sound data and the speaking time data to each other are collectively referred to as relation recording data. Other additional data may be added to the relation recording data.

The administrator (for example, the teacher) of the educational system can freely read, from data recorded in the recording medium 36, the relation recording data on an individual speaker basis. For example, when the administrator wants to listen to the remarks of the student ST[2], the administrator inputs the unique number or the like of the student ST[2] to the PC 2, and can thereby reproduce, with the student ST[2] being the speaker, a picture and sound on an arbitrary reproduction device (for example, the PC 2). The relation recording data can also be utilized as the minutes of the content of the class including a picture and sound.

[Technology α2]

Technology α2 will be described. Although, in the present embodiment, the camera drive mechanism 17 is assumed to be used, in technology α2, the digital camera 1 is arranged such that all the students ST[1] to ST[16] are placed within the shooting range of the image sensing portion 11 without the use of the camera drive mechanism 17, and, after the detection of the speaker, the image data on the speaker image data is obtained from the image data on the frame image, using the same trimming as the extraction portion 22 of the first embodiment.

[Technology α3]

Technology α3 will be described. In discussion, a plurality of students is likely to simultaneously produce sounds. In technology α3, a plurality of students are assumed to simultaneously produce sounds, and sound signals for a plurality of speakers are individually produced. Consider, for example, a state where the students ST[1] and ST[4] simultaneously become the speakers and simultaneously produce sounds. Based on the output sound signals of the microphones 13A and 13B, the speaker sound signal generation portion 34 enhances, with directivity control, a signal component of sound coming from the student ST[1] and thereby extracts the speaker sound signal of the student ST[1] from the output sound signals of the microphones 13A and 13B; on the other hand, based on the output sound signals of the microphones 13A and 13B, the speaker sound signal generation portion 34 enhances, with directivity control, a signal component of sound coming from the student ST[4] and thereby extracts the speaker sound signal of the student ST[4] from the output sound signals of the microphones 13A and 13B. To separate and extract the speaker sound signals of the students ST[1] and ST[4], any of directivity control methods (for example, the methods disclosed in JP-A-2000-81900 and JP-A-10-313497) including known methods can be used.

The sound incoming direction determination portion 32 can determine sound incoming directions corresponding to the students ST[1] and ST[4] from the speaker sound signals of the students ST[1] and ST[4], respectively. In other words, the sound incoming direction determination portion 32 can detect the angles θ_{ST[1]} and θ_{ST[4]}. Based on the detected angles θ_{ST[1]} and θ_{ST[4]}, the speaker detection portion 31 determines that both the students ST[1] and ST[4] are the speakers.

When a plurality of speakers simultaneously produce sounds, the control portion 35 can individually record the speaker sound signals of the speakers in the recording medium 36. For example, the speaker sound signal of the student ST[1] who is the first speaker is treated as an L channel sound signal, and the speaker sound signal of the student ST[4] who is the second speaker is treated as a R channel sound signal, and those sound signals can be recorded as stereo sound. When Q speakers simultaneously produce sounds (Q is an integer of three or more), the speaker sound signals of the Q speakers may be treated as individual channel signals, and multichannel signals (for example, 5.1 channel signals) formed from the Q channel signals may be recorded in the recording medium 36.

When the speaker detection portion 31 determines that both the students ST[1] and ST[4] are the speakers, the angle of view of the shooting of the image sensing portion 11 may be adjusted and the direction of the shooting of the image sensing portion 11 may be adjusted with the camera drive mechanism 17 as necessary such that both the students ST[1] and ST[4] are simultaneously placed within the shooting range of the image sensing portion 11. By using the method described in the first embodiment to make the speaker detection portion 31 of FIG. 20 individually generate the speaker information on the students ST[1] and ST[4] (also see FIG. 5) and to perform, on the frame image, the trimming based on each piece of speaker information, the speaker image data generation portion 33 may individually generate the speaker image data on the students ST[1] and ST[4]. Furthermore, the recording with the relation on an individual speaker basis that is described in technology α1 may be performed.

[Technology α4]

Technology α4 will be described. A plurality of loudspeakers may be arranged within the classroom 500, and, with all or part of the loudspeakers, the speaker sound signal may be reproduced in real time. For example, as shown in FIG. 22, in the four corners of the rectangular classroom 500, loudspeakers SP1 to SP4 are arranged one by one. When each of the students ST[1] and ST[4] is not the speaker, the sound signal based on the output sound signal of the microphone portion 13 or an arbitrary sound signal can be reproduced by all or part of the loudspeakers SP1 to SP4.

A headphone may be allocated to each of the students ST[1] to ST[ 16], and each headphone may reproduce the sound signal based on the output sound signal of the microphone portion 13 (for example, the speaker sound signal) or an arbitrary sound signal. For example, the PC 2 controls the reproduction using the loudspeakers SP1 to SP4 and the reproduction using the headphones.

[Technology α5]

Technology α5 will be described. Although, in the present embodiment, the microphone portion 13 is assumed to be composed of the two microphones 13A and 13B, the number of microphones included in the microphone portion 13 may be three or more, and the number of microphones used for the formation of the speaker sound signal may be three or more.

Technologies α1 to α5 can also be applied to the first, second, third or fourth embodiment described above (however, technology α2 is omitted). When technology α1 described above is performed in the first, second, third or fourth embodiment, within any arbitrary device (for example, the digital camera 1 or the PC 2) of the educational system of the first, second, third or fourth embodiment, the control portion 35 and the recording medium 36 are preferably provided. When technology α3 described above is performed in the first, second, third or fourth embodiment, within any arbitrary device (for example, the digital camera 1 or the PC 2) of the educational system of the first, second, third or fourth embodiment, the speaker detection portion 31, the speaker image data generation portion 33, the speaker sound signal generation portion 34, the control portion 35 and the recording medium 36 are preferably provided.

### Sixth Embodiment

A sixth embodiment of the present invention will be described. An overall diagram showing the configuration of an educational system (presentation system) according to the sixth embodiment is the same as in the first embodiment (see FIG. 1). Unless otherwise a contradiction arises, what has been described in the fifth embodiment may be applied to the sixth embodiment. In the following description, as in the fifth embodiment, the camera drive mechanism 17 is assumed to be provided in the digital camera 1.

Even in the sixth embodiment, the educational environment EE_{A} shown in FIGS. 19A and 19B is assumed. However, in the sixth embodiment, as shown in FIG. 23A, within the classroom 500 in the educational environment ER_{A}, four microphones MC1 to MC4 that are different from the microphone portion 13 of FIG. 4 are provided. As shown in FIG. 24, the microphones MC1 to MC4 form a microphone portion 550. A speaker detection portion 552 and a sound signal processing portion 551 including a speaker sound signal generation portion 553 are provided within the digital camera 1 or the PC 2 of FIG. 1. The microphone portion 550 shown in FIG. 24 may also be considered as a constituent element of the educational system. The microphones MC1 to MC4 are arranged in the four corners of the classroom 500, which are in different positions within the classroom 500. For convenience, an educational environment in which the microphones MC1 to MC4 are arranged in the educational environment EE_{A} is referred to as an educational environment EB_{B}. The number of microphones that form the microphone portion 550 is not limited to four but is preferably two or more.

As shown in FIG. 23B, the area within the classroom 500 can be divided into division areas 541 to 544. Among the microphones MC1 to MC4, each position within the division area 541 is closest to the microphone MC1, each position within the division area 542 is closest to the microphone MC2, each position within the division area 543 is closest to the microphone MC3 and each position within the division area 544 is closest to the microphone MC4. Within the division area 541, the students ST[1], ST[2], ST[5] and ST[6] are arranged; within the division area 542, the students ST[3], ST[4], ST[7] and ST[8] are arranged; within the division area 543, the students ST[9], ST[10], ST[13] and ST[14] are arranged; and within the division area 544, the students ST[11], ST[12], ST[15] and ST[ 16] are arranged. Hence, among the microphones MC1 to MC4, the microphone closest to the students ST[1], ST[2], ST[5] and ST[6] is the microphone MC1, the microphone closest to the students ST[3], ST[4], ST[7] and ST[8] is the microphone MC2, the microphone closest to the students ST[9], ST[10], ST[13] and ST[14] is the microphone MC3 and the microphone closest to the students ST[11], ST[12], ST[15] and ST[16] is the microphone MC4.

Each of the microphones MC1 to MC4 converts its ambient sound into a sound signal, and outputs the obtained sound signal to the sound signal processing portion 551.

The speaker detection portion 552 detects the speaker based on the output sound signals of the microphones MC1 to MC4. As described above, each position within the classroom 500 is made to correspond to any one of the microphones MC1 to MC4, and consequently, each student within the classroom 500 is made to correspond to any one of the microphones MC1 to MC4. The sound signal processing portion 551 including the speaker detection portion 552 can be made to previously recognize such a correspondence between the students ST[1] to ST[16] and the microphones MC1 to MC4.

The speaker detection portion 552 compares the magnitudes of the output sound signals of the microphones MC1 to MC4, and determines that the speaker is present within the division area corresponding to the maximum magnitude. The magnitude of the output sound signal refers to the level or the power of the output sound signal. Among the microphones MC1 to MC4, the microphone in which the magnitude of the output sound signal is the maximum is referred to as a speaker vicinity microphone. For example, when the microphone MC1 is the speaker vicinity microphone, any of the students ST[1], ST[2], ST[5] and ST[6] within the division area 541 corresponding to the microphone MC1 is determined to be the speaker; when the microphone MC2 is the speaker vicinity microphone, any of the students ST[3], ST[4], ST[7] and ST[8] within the division area 542 corresponding to the microphone MC2 is determined to be the speaker. The same is true in the case where the microphone MC3 or MC4 is the speaker vicinity microphone.

When the speaker vicinity microphone is the microphone MC1, the students ST[1], ST[2], ST[5] and ST[6] may be placed within the shooting range of the image sensing portion 11 using the camera drive mechanism 17, and, in this state, based on image data on the obtained frame image, which one of the students ST[1], ST[2], ST[5] ₐₙd ST[6] is the speaker may be specified. Likewise, when the speaker vicinity microphone is the microphone MC2, the students ST[3], ST[4], ST[7] and ST[8] may be placed within the shooting range of the image sensing portion 11 using the camera drive mechanism 17, and, in this state, based on image data on the obtained frame image, which one of the students ST[3], ST[4], ST[7] and ST[8] is the speaker may be specified. The same is true in the case where the microphone MC3 or MC4 is the speaker vicinity microphone. As the method of detecting the speaker from a plurality of students based on the image data on the frame image, the method described in the first embodiment can be utilized.

Although the educational environment is different from the educational environment EE_{B}, if only one student is present within each of the division areas, and specifically, for example, if the students ST[1], ST[4], ST[13] and ST[16] are only present within the division areas 541, 542, 543 and 544, respectively (see FIGS. 19A and 23B), it is possible to specify the speaker by detecting the speaker vicinity microphone alone. In other words, in this case, if the speaker vicinity microphone is the microphone MC1, the student ST[1] is specified as the speaker; if the speaker vicinity microphone is the microphone MC2, the student ST[4] is specified as the speaker (the same is true in the case where the microphone MC3 or MC4 is the speaker vicinity microphone),

The speaker sound signal generation portion 553 (hereinafter referred to as the generation portion 553 for short) generates the speaker sound signal including a component of sound from the speaker detected by the speaker detection portion 552. When, among the microphones MC1 to MC4, the output sound signal of the microphone (that is, the speaker vicinity microphone) corresponding to the speaker is assumed to be MC_{A}, and the output sound signals of the other three microphones are assumed to be MC_{B}, MC_{C} and MC_{D}, a sound signal MIX obtained by signal mixing according to the formula “MIX=k_{A}·MC_{A}+k_{B}·MC_{B}+k_{C}·MC_{C}+k_{D}·MC_{D}” can be generated as the speaker sound signal. Here, k_{B}, k_{C} and k_{D} each are zero or a positive value; k_{A} is a value greater than each of k_{B}, k_{C} and k_{D}.

After the detection of the speaker or in the process of the detection, the speaker detection portion 552 can perform shooting control in which to note the speaker. This shooting control also includes the control in which the direction of the optical axis of the image sensing portion 11 is changed with the camera drive mechanism 17 such that the speaker is placed within the shooting range of the image sensing portion 11. Furthermore, for example, the direction of the optical axis of the image sensing portion 11 may be changed with the camera drive mechanism 17 such that, among the faces of the students ST[1] to ST[16], only the face of the student who is the speaker is placed within the shooting range of the image sensing portion 11; in this case, as necessary, the angle of view of the shooting of the image sensing portion 11 may be controlled.

When the frame image obtained by performing shooting with the speaker placed within the shooting range of the image sensing portion 11 is the frame image 530 of FIG. 21, as in the fifth embodiment, the PC 2 receives, by communication, the image data on the frame image 530 from the digital camera 1, and can display, as a picture, on the screen 4, the frame image 530 itself or an image based on the frame image 530.

The speaker image data generation portion 33 may be provided in the educational system of the sixth embodiment, and the speaker image data may be generated by the speaker image data generation portion 33 based on the result of the detection of the speaker by the speaker detection portion 552 according to the method described in the first or fifth embodiment. The speaker information described in the first embodiment may be generated by the speaker detection portion 552 of FIG. 24; in this case, the speaker image data generation portion 33 can extract the speaker image data, based on the speaker information, from the image data on the frame image 530. An image indicated by the speaker image data can also be displayed as a picture on the screen 4.

Preferably, the control portion 35 and the recording medium 36 of FIG. 20 are provided in the educational system of the sixth embodiment, and the recording operation described in the fifth embodiment is performed on them. It is possible to record, in the recording medium 36, arbitrary data such as image data (for example, speaker image data) based on the output from the image sensing portion 11 and sound signal data (for example, data indicating the speaker sound signal) based on the output of the microphone portion 550; it is also possible to transmit the arbitrary data to an arbitrary device of the educational system; and it is also possible to reproduce the arbitrary data at an arbitrary reproduction device. In a period of time during which the speaker is not specified, a sound signal obtained by mixing the output sound signals of the microphones MC1 to MC4 in the same proportions can be recorded in the recording medium 36.

Since, even in the present embodiment, all the students can listen to the remarks of the speaker while watching the face of the speaker, the same effects as in the first embodiment can be obtained.

After the speaker is detected with the output sound signals of the microphones 13A and 13B according to the method described in the fifth embodiment, based on the result of the detection of the speaker, the speaker sound signal may be generated from the output sound signals of the microphones MC1 to MC4. Alternatively, after the speaker is detected with the output sound signals of the microphones MC1 to MC4, as in the fifth embodiment, the speaker sound signal may be generated from the output sound signals of the microphones 13A and 13B.

Even in the sixth embodiment, technologies α1, α2 and α5 described above can be performed.

Even in the sixth embodiment, technology α3 described above can be performed. When technology α3 is performed in the sixth embodiment, the speaker detection portion 552 can determine according to the method described in technology α3 that a plurality of students are the speakers. Thus, for example, if the students ST[1] and ST[4] are determined to be the speakers, the speaker sound signal generation portion 553 generates, while regarding the microphone MC1 corresponding to the student ST[1] as the speaker vicinity microphone, the speaker sound signal corresponding to the student ST[1] from the output sound signals (or only the output sound signal of the microphone MC1) of the microphones MC1 to MC4, and, on the other hand, the speaker sound signal generation portion 553 generates, while regarding the microphone MC2 corresponding to the student ST[4] as the speaker vicinity microphone, the speaker sound signal corresponding to the student ST[4] from the output sound signals (or only the output sound signal of the microphone MC2) of the microphones MC1 to MC4. The generated speaker sound signals of a plurality of speakers can be recorded according to the method described in technology α3.

Even in the sixth embodiment, technology α4 described above can be performed. In this case, in consideration of howling, a loudspeaker for reproduction of the speaker sound signal may be selected. Specifically, technology α4 is preferably performed as follows. It is assumed that the loudspeakers SP1 to SP4 shown in FIG. 22 are arranged near the microphones MC1 to MC4, respectively, and are arranged within the division areas 541 to 544, respectively (also see FIGS. 23A and 23B). The PC 2 selects, based on the result of the detection of the speaker, the loudspeaker for reproduction of the speaker sound signal from the loudspeakers SP1 to SP4, and reproduces the speaker sound signal only with the selected loudspeaker for reproduction. As the loudspeaker for reproduction, one, two or three of the loudspeakers SP1 to SP4 are used; the loudspeaker closest to the speaker is omitted from the loudspeakers for reproduction Thus, it is possible to reduce the occurrence of howling. Specifically, for example, when the speaker is the student ST[1], the loudspeaker MC1 is not selected as the loudspeaker for reproduction, and all or part of the loudspeakers MC2, MC3 and MC4 are selected as loudspeakers for reproduction. A correspondence between the speaker and the loudspeaker needed to be selected as the loudspeaker for reproduction may be stored as table data in the PC 2, and the loudspeaker for reproduction may be selected using the table data. For example, information such as a piece of information that the loudspeakers for reproduction corresponding to the student ST[1] are the loudspeakers MC2, MC3 and MC4 and a piece of information that the loudspeakers for reproduction corresponding to the student ST[4] are the loudspeakers MC1, MC3 and MC4 is stored as the table data.

### Seventh Embodiment

A seventh embodiment of the present invention will be described. The seventh embodiment is an embodiment obtained by varying part of the sixth embodiment; what has been described in the sixth embodiment is applied to what is not particularly described in the present embodiment.

In the seventh embodiment, a student microphone is allocated to each of the students ST[1] to ST[16]. A student microphone that is allocated to the student ST[i] is represented by MT[i] (see FIG. 25). The student microphones MT[1] to MT[16] are arranged in the vicinity of the students ST[1] to ST[16] and collect voices of the students ST[1] to ST[16], respectively. The student microphone MT[i] converts the voice of the student ST[i] into a sound signal, and can output the obtained sound signal to the sound signal processing portion 551 (see FIG. 24). A classroom environment in which the student microphones MT[1] to ST[16] are added to the classroom environment EE_{B} assumed in the sixth embodiment is referred to as a classroom environment EE_{C}.

The speaker detection portion 552 of FIG. 24 can detect the speaker by the method described in the sixth embodiment or detect the speaker based on the output sound signals of the student microphones MT[1] to MT[ 16].

For example, the detection in the latter case can be achieved as follows. The speaker detection portion 552 determines that, among the output sound signals of the student microphones MT[1] to MT[16], the student microphone in which the magnitude of the output sound signal is the maximum is a speaking student microphone or determines that the student microphone in which the magnitude of the output sound signal is a predetermined level or more is the speaking student microphone. The student corresponding to the speaking student microphone can be detected as the speaker. Hence, if the student microphone MT[i] is determined to be the speaking student microphone, the student ST[i] can be detected to be the speaker.

The generation portion 553 of FIG. 24 can generate the speaker sound signal by the method described in the sixth embodiment or generate the speaker sound signal based on the output sound signals of the student microphones MT[1] to MT[16].

For example, the generation in the latter case can be achieved as follows. After the speaking student microphone is specified by the method described above, the generation portion 553 can generate the output sound signal itself of the speaking student microphone as the speaker sound signal or can generate the speaker sound signal by performing predetermined signal processing on the output sound signals of the speaking student microphone. The speaker sound signal generated by the generation portion 553 naturally includes a component of sound from the speaker.

It is possible to record, in the recording medium 36, arbitrary data such as image data (for example, speaker image data) based on the output from the image sensing portion 11 and sound signal data (for example, data indicating the speaker sound signal) based on the output of the student microphones MT[1] to MT[16]; it is also possible to transmit the arbitrary data to an arbitrary device of the educational system; and it is also possible to reproduce the arbitrary data at an arbitrary reproduction device.

### Eighth Embodiment

An eighth embodiment of the present invention will be described. An overall diagram showing the configuration of an educational system (presentation system) according to the eighth embodiment is the same as in the first embodiment (see FIG. 1). The classroom environment of the eighth embodiment is the same as the classroom environment EE_{A}, EE_{B} or EE_{C} of the fifth, sixth or seventh embodiment. The camera drive mechanism 17 may be provided in the digital camera 1 of the eighth embodiment (see FIG. 18). Here, as in the first embodiment, the location in which the digital camera 1 is arranged and the direction in which the shooting is performed are assumed to be fixed such that all the students ST[1] to ST[16] are always placed within the shooting range of the digital camera 1.

FIG. 26 is a partial block diagram of the educational system according to the eighth embodiment; the educational system includes a personal image generation portion 601 and a display control portion 602. Portions shown in FIG. 26 are provided within any arbitrary device of the educational system; all or part of those can also be provided in the digital camera 1 or the PC 2. For example, the personal image generation portion 601 may be provided within the digital camera 1; the display control portion 602 may be provided within the PC 2.

The image data on the frame image is fed from the image sensing portion 11 to the personal image generation portion 601. The personal image generation portion 601 performs the face detection processing based on the image data on the frame image and described in the first embodiment, thereby individually extracts the face regions of the students ST[1] to ST[16] from the entire image region of the frame image and individually generates, as personal images, images within the face regions of the students ST[1] to ST[16]. A personal image of the student ST[i] that is an image within the face region of the student ST[i] is represented by IS[i]. Image data on personal images IS[1] to IS[16] is fed to the display control portion 602. A plurality of digital cameras may be used to generate the personal images IS[1] to IS[16].

The teacher, who is the operator of the PC 2, performs a predetermined operation on the PC 2, and thereby can start a speaker specification program on the PC 2. When the speaker specification program is started, the display control portion 602 selects one or a plurality of personal images from the personal images IS[1] to IS[ 16], and displays the selected personal image on the screen 4. The selected personal image is changed at a predetermined period (for example, 0.5 second); this change is made according to random numbers produced on the PC 2 or the like. Hence, when the speaker specification program is started, the personal images IS[1] to IS[16] are sequentially displayed on the screen 4 by performing a plurality of steps for the display while the personal image displayed on the screen 4 is being randomly changed among the personal images IS[1] to IS[16].

While the speaker specification program is being operated, the teacher, who is the operator of the PC 2, performs a particular operation on the PC 2 or the like, and a trigger signal is generated within the PC 2. Regardless of the particular operation, the trigger signal may be automatically generated within the PC 2 according to random numbers or the like. The generated trigger signal is fed to the display control portion 602. When the display control portion 602 receives the trigger signal, the display control portion 602 stops the changing of the personal image displayed on the screen 4, and provides information that the student corresponding to the personal image needs to become the speaker, using a picture on the screen 4 or the like.

Specifically, for example, when the personal image displayed at the time of the generation of the trigger signal is the personal image IS[2], after the generation of the trigger signal, the display control portion 602 fixes the personal image displayed on the screen 4 to the personal image IS[2], and provides information that the student ST[2] corresponding to the personal image IS[2] needs to become the speaker to the students by displaying, on the screen 4, a message saying, for example, “please speak.” After receiving this provision, the student ST[2] actually becomes the speaker and speaks.

Operations performed after the speaker is specified are the same as described in any of the embodiments discussed above; the generation, the recording, the transmission, the reproduction and the like of the speaker image data, the speaker sound signal and the like are performed within the educational system. Specifically, for example, in a period of time during which the student ST[2] is actually the speaker and speaks after the generation of the trigger signal, as in each of the embodiments described above, the personal image IS[2] of the student ST[2] who is the speaker is displayed on the screen 4. Image data on the personal image IS[2] of the student ST[2] who is the speaker corresponds to the speaker image data described above.

Since the display of a picture of the speaker allows all the students to listen to the remarks of the speaker while watching the face of the speaker, the same effects as in the first embodiment can be obtained. A rule that the student displayed as a picture becomes the speaker is introduced into an educational site, and thus, for example, the feeling of tension in the class is enhanced, and the efficiency of learning of students is expected to be enhanced.

Instead of the method described above, the following method may be used to specify the speaker. Information on a correspondence between the positions of 16 desks corresponding to the students ST[1] to ST[ 16] and positions in the shooting range of the image sensing portion 11 is previously given to the educational system. In other words, correspondence information indicating, on an individual desk basis (that is, on an individual student basis), at which portion of the frame image the desk of the student ST[i] is present is previously given to the educational system. The teacher, who is the operator of the PC 2, performs a predetermined operation on the PC 2, and thereby can start a second speaker specification program on the PC 2. When the second speaker specification program is started, a picture representing the 16 desks (in other words, seats) within the classroom 500 is displayed on the display screen of the PC 2, and the teacher performs a predetermined operation, and thereby selects any one of the desks displayed on the display screen of the PC 2. The PC 2 determines that the student corresponding to the selected desk needs to be the speaker, and uses the correspondence information to acquire, from the personal image generation portion 601, the personal image of the student corresponding to the selected desk. The acquired personal image is displayed on the screen 4 as the picture of the student who needs to be the speaker.

For example, after the second speaker specification program is stated, when the desk corresponding to the student ST[2] is selected on the PC 2, it is found from the correspondence information that the personal image of the student corresponding to the selected desk is the personal image IS[2]. Hence, the personal image IS[2] is displayed on the screen 4 as the picture of the student who needs to be the speaker.

### Ninth Embodiment

A ninth embodiment of the present invention will be described. In the ninth embodiment, varied technologies or supplementary technologies that are concerned with the embodiments described above and that particularly focus on the satellite classroom will be described. FIG. 27 shows two classrooms R_{A} and R_{B}. In the classroom R_{A}, a digital camera 1_{A}, a PC 2_{A}, a projector 3_{A} and a screen 4_{A} are arranged; in the classroom R_{B}, a digital camera 1_{B}, a PC 2_{B}, a projector 3_{B} and a screen 4_{B} are arranged. As the digital cameras 1_{A} and 1_{B}, the digital camera 1 can be used; as the PCs 2_{A} and 2_{B}, the PC 2 can be used; as the projectors 3_{A} and 3_{B}, the projector 3 can be used; as the screens 4_{A} and 4_{B}, the screen 4 can be used.

Picture information is fed from the projector 3_{A} to the screen 4_{A}, and thus a picture corresponding to the picture information is displayed on the screen 4_{A}. Likewise, picture information is fed from the projector 3_{B} to the screen 4_{B}, and thus a picture corresponding to the picture information is displayed on the screen 4_{B}. On the other hand, the same picture information as that fed from the projector 3_{A} to the screen 4_{A} is transmitted wirelessly or by wire to the projector 3_{B}, and thus the same picture as that on the screen 4_{A} can be displayed on the screen 4_{B}. Conversely, the same picture information as that fed from the projector 3_{B} to the screen 4_{B} is transmitted wirelessly or by wire to the projector 3_{A}, and thus the same picture as that on the screen 4_{B} can be displayed on the screen 4_{A}.

Although not shown in FIG. 27, an arbitrary loudspeaker described in any of the embodiments discussed above can be arranged in each of the classrooms R_{A} and R_{B}, and an arbitrary microphone described in any of the embodiments discussed above can be arranged in each of the classrooms R_{A} and. R_{B}. An arbitrary sound signal (for example, the speaker sound signal) based on the output sound signal of the microphone within the classroom R_{A} can be reproduced by an arbitrary loudspeaker within the classroom R_{A}. Likewise, an arbitrary sound signal (for example, the speaker sound signal) based on the output sound signal of the microphone within the classroom R_{B} can be reproduced by an arbitrary loudspeaker within the classroom R_{B}. On the other hand, the same sound signal as that fed to the loudspeaker within the classroom R_{A} is transmitted wirelessly or by wire to the loudspeaker within the classroom R_{B}, and thus the same sound signal as that reproduced by the loudspeaker within the classroom R_{A} can be reproduced by the loudspeaker within the classroom R_{B}. Conversely, the same sound signal as that fed to the loudspeaker within the classroom R_{B} is transmitted wirelessly or by wire to the loudspeaker within the classroom R_{A}, and thus the same sound signal as that reproduced by the loudspeaker within the classroom R_{B} can be reproduced by the loudspeaker within the classroom R_{A}.

One or more students are present in each of the classrooms R_{A} and R_{B}. Each student within the classroom R_{A} is placed within the shooting range of the digital camera 1_{A}; each student within the classroom R_{A} is placed within the shooting range of the digital camera 1_{B}.

Among the classrooms R_{A} and R_{B}, the classroom other than the satellite classroom is referred to as a main classroom. The classrooms other than the satellite classroom and described in the embodiments discussed above correspond to the main classrooms. Any one of the classrooms R_{A} and R_{B} can be the main classroom; any one of the classrooms R_{A} and R_{B} can be the satellite classroom. Here, it is assumed that the classroom R_{A} is the main classroom and the classroom R_{B} is the satellite classroom. Two or more satellite classrooms may be present.

In the first embodiment, the technology for distributing the picture information and the like to the satellite classroom has been described; a further description will be given of this technology.

For example, it is assumed that, as shown in FIG. 28, four students 811 to 814 are present in the classroom R_{A}, and that four students 815 to 818 are present in the classroom R_{B}. In this case, the image sensing portion 11 of the digital camera 1_{A} and the image sensing portion 11 of the digital camera 1_{B} can be considered to form a multiple eye shooting portion 851 that shoots the eight students 811 to 818 (see FIG. 29).

The speaker detection portion 21 (see FIG. 5) of the digital camera 1_{A} can detect the speaker from the students 811 to 814 based on the output of the image sensing portion 11 of the digital camera 1_{A}; the speaker detection portion 21 of the digital camera 1_{B} can detect the speaker from the students 815 to 818 based on the output of the image sensing portion 11 of the digital camera 1_{B}. Then, the speaker detection portion 21 of the digital camera 1_{A} and the speaker detection portion 21 of the digital camera 1_{B} can also be considered to form, based on the output of the multiple eye shooting portion 851, a comprehensive speaker detection portion 852 that detects the speaker from the students 811 to 818 on the image (see FIG. 29).

The extraction portion 22 (see FIG. 5) of the digital camera 1_{A} can generate the speaker image data based on the speaker information from the speaker detection portion 21 of the digital camera 1_{A} and the image data from the image sensing portion 11 of the digital camera 1_{A}; the extraction portion 22 of the digital camera 1_{B} can generate the speaker image data based on the speaker information from the speaker detection portion 21 of the digital camera 1_{B} and the image data from the image sensing portion 11 of the digital camera 1_{B}. Then, the extraction portion 22 of the digital camera 1_{A} and the extraction portion 22 of the digital camera 1_{B} can also be considered to form a comprehensive extraction portion 853 that extract, based on the result of the detection by the comprehensive speaker detection portion 852, image data on an image portion of the speaker, from the output of the multiple eye shooting portion 851, as the speaker image data (see FIG. 29).

When, among the students 811 to 818, the student 811 is the speaker, the comprehensive speaker detection portion 852 detects from the output of the multiple eye shooting portion 851 that the student 811 is the speaker, and the comprehensive extraction portion 853 extracts, from the output of the multiple eye shooting portion 851, the image data on the image portion of the student 811, as the speaker image data. Consequently, a picture (picture of the face of the student 811) based on the speaker image data is displayed both on the screen 4_{A}, which the students 811 to 814 can visually recognize, and on the screen 4_{B}, which the students 815 to 818 can visually recognize. The screen 4_{A} and the screen 4_{B} can also be considered to form a display screen 854 that the students 811 to 818 can visually recognize (see FIG. 29).

Although it is assumed that four students are present in each of the classrooms R_{A} and R_{B}, part of the students who need to be in each of the classrooms may be absent, with the result that it is likely that, for example, only one student is present within the classroom R_{A}, only one student is present within the classroom R_{B} or only one student is present in each of the classrooms R_{A} and R_{B}. Even in those conditions, the same operations as described above are performed.

Although a detailed description has been given of the method of applying the educational system to a plurality of classrooms, focusing on the first embodiment, even in the above embodiments other than the first embodiment, the same way of thinking can be performed. The way of thinking is that, when all the students in the educational system are held within one classroom, preferably, a group of necessary devices are simply arranged in the one classroom whereas, when all the students in the educational system are separated and held into a plurality of classrooms, preferably, a group of necessary devices are simply arranged in each classroom. The group of necessary devices include the digital camera 1, the PC 2, the projector 3 and the screen 4; as necessary, the group of necessary devices further include an arbitrary loudspeaker and an arbitrary microphone described in any of the embodiments discussed above.

For example, when, in the fifth to seventh embodiments, Y students in the educational system are separated and held into Z classrooms (Y and Z are an integer of two or more), the image sensing portions 11 (a total of Z image sensing portions) of the digital cameras 1 arranged in the Z classrooms can be considered to form a multiple eye shooting portion that shoots the Y students, the microphones arranged in the Z classrooms can be considered to form a comprehensive microphone portion that outputs a sound signal corresponding to an ambient sound of the multiple eye shooting portion and the educational system can be considered to include a comprehensive speaker detection portion that detects the speaker from the Y students based on the output sound signal of the comprehensive microphone portion.

When the Y students are the students ST[1] to ST[16] described in the fifth embodiment and the like (see FIG. 19A and the like), if the students ST[9] to ST[16] cannot be held within the classroom 500, the students ST[9] to ST[ 16] are held within a satellite classroom different from the classroom 500. In this case, since the students ST[9] to ST[16] held within the satellite classroom are not placed within the shooting range of the digital camera 1 in the classroom 500, preferably, the image sensing portion for shooting the students ST[1] to ST[16] is simply separated into an image sensing portion for shooting the students ST[1] to ST[8] and an image sensing portion for shooting the students ST[9] to ST[16]. The same is true of the microphones and the loudspeakers.

As described above, each of the constituent elements (for example, the image sensing portion, the display screen, the microphone portion composed of a plurality of microphones and a loudspeaker portion composed of a plurality of loudspeakers) of the educational system may be separated and arranged into a plurality of classrooms .

### Tenth Embodiment

Tenth embodiment of the present invention will be described. In the tenth embodiment, an example of a projector that can be utilized as the projector in each of the embodiments discussed above will be described. A screen in the present embodiment corresponds to the screen in each of the embodiments discussed above.

FIG. 30 is a diagram showing the appearance and configuration of the projector 3001 according to the present embodiment. In the present embodiment, for convenience, a direction of the screen seen from the projector 3001 is defined as a front direction, the direction opposite the front direction is defined as a back direction and the rightward direction and the leftward direction when the projector 3001 is seen from the side of the screen are defined as a rightward direction and a leftward direction, respectively. Directions perpendicular to the front-and-back and leftward-and-rightward directions are an upward direction and a downward direction. Of the upward direction and the downward direction, a direction closer to a direction pointing from the projector 3001 to the screen is defined as the upward direction. The downward direction is the direction opposite the upward direction.

The projector 3001 of the present embodiment is the so-called short focus projection projector. Since the short focus projection projector requires only a small space for installation, the short focus projection projector is suitable for educational sites and the like. The projector 3001 includes a substantially rectangular body cabinet 3010. In the upper surface of the body cabinet 3010, a first inclined surface 3101 that extends backward while dropping and a second inclined surface 3102 that extends, from the first inclined surface 3101, backward while rising are formed. The second inclined surface 3102 points obliquely upward and frontward; a projection port 3103 is formed in the second inclined surface 3102. Picture light emitted obliquely upward and frontward from the projection port 3103 is enlarged and projected on the screen arranged in front of the projector 3001.

FIGS. 31 and 32 are diagrams showing the internal configuration of the projector 3001. FIG. 31 is a perspective view of the projector 3001; FIG. 32 is a plan view of the projector 3001. For convenience, in FIGS. 31 and 32, the body cabinet 3010 is indicated by alternate long and short dashed lines.

As shown in FIG. 32, when seen from above, the body cabinet 3010 can be divided into four regions as indicated by two alternate long and short dashed lines L1 and L2. In the following description, for ease of description, among the four regions, a region formed in the rightward front part is defined as a first region, a region diagonally arranged with respect to the first region is defined as a second region, a region formed in the leftward front part is defined as a third region and a region diagonally arranged with respect to the third region is defined as a fourth region.

With reference to FIGS. 31 and 32, a light source device 3020, a light guide optical system 3030, a DMD (digital micro-mirror device) 3040, a projection optical unit 3050, a control circuit 3060 and an LED drive circuit 3070 are arranged within the body cabinet 3010.

The light source device 3020 has three light source units 3020R, 3020G and 3020B. The red light source unit 3020R is formed with a red light source 3201R that emits light of a red wavelength band (hereinafter referred to as “R light”) and a heat sink 3202R for discharging heat generated by the red light source 3201R. The green light source unit 3020G is formed with a green light source 3201 G that emits light of a green wavelength band (hereinafter referred to as “G light”) and a heat sink 3202G for discharging heat generated by the green light source 3201G. The blue light source unit 3020B is formed with a blue light source 3201B that emits light of a blue wavelength band (hereinafter referred to as “B light”) and a heat sink 3202B for discharging heat generated by the blue light source 3201B.

The light sources 3201R, 3201G and 3201B are high-output LED light sources and are formed with LEDs (red LED, green LED and blue LED) arranged on a substrate. The red LED is formed with, for example, AlGaInP (aluminum indium gallium phosphide); the green LED and the blue LED are formed with, for example, GaN (gallium nitride).

The light guide optical system 3030 is formed with: first lenses 3301R, 3301G and 3301B and second lenses 3302R, 33020 and 3302B that are provided for the light sources 3201R, 3201G and 3201B; a dichroic prism 3303; a hollow rod integrator (hereinafter referred to as a hollow rod for short) 3304; two mirrors 3305 and 3307; and two relay lenses 3306 and 3308.

The R light, the G light and the B light emitted from the light sources 3201R, 3201G and 3201B are collimated by the first lenses 3301R, 3301G and 3301B and the second lenses 3302R, 3302G and 3302B, and the optical paths thereof are combined by the dichroic prism 3304.

The light (the R light, the B light and the G light) emitted from the dichroic prism 3304 enters the hollow rod 3304. The hollow rod 3304 is hollow; its inside surface is a mirror surface. The hollow rod 3304 has such a tapered shape that, as the hollow rod 3304 extends from the side of an incident end surface to the side of an emission end surface, its cross-sectional area is increased. In the hollow rod 3304, the light is repeatedly reflected off the mirror surface, and the distribution of illumination on the emission end surface is made uniform.

Since the hollow rod 3304 is used, its refractive index is lower than that of the solid rod integrator (the refractive index of air <the refractive index of glass), and thus it is possible to reduce the length of the rod.

The light emitted from the hollow rod 3304 is applied to the DMD 3040 by reflection off the mirrors 3305 and 3307 and by the action of the relay lenses 3306 and 3308.

The DMD 3040 includes a plurality of miromirrors arranged in a matrix. One micromirror forms one pixel. The micromirrors are rapidly driven on and off based on DMD drive signals corresponding to the R light, the G light and the B light that are incident on the micromirrors.

By changing the angle of inclination of the micromirrors, the light (the R light, the G light and the B light) from the light sources 3201R, 3201G and 3201B is modulated. Specifically, when the micromirror of a certain pixel is off, light reflected off this micromirror does not enter a lens unit 501. On the other hand, when the micromirror is on, the light reflected off this micromirror enters the lens unit 3501. By adjusting the proportion of a time period during which the micromirror is on, the gradation of an image is adjusted on an individual pixel basis.

The projection optical unit 3050 is formed with the lens unit 3501, a curved mirror 3502 and a housing 3503 that holds these.

The light (picture light) modulated by the DMD 3040 passes through the lens unit 3501 and is emitted toward the curved mirror 3502. The picture light is reflected off the curved minor 3502 and is emitted to the outside through the projection port 3103 formed in the housing 3503.

FIG. 33 is a block diagram showing the configuration of the projector according to the present embodiment.

With reference to FIG. 33, the control circuit 3060 includes a signal input circuit 3601, a signal processing circuit 3602 and a DMD drive circuit 3603.

The signal input circuit 3601 outputs, to the signal processing circuit 3602, video signals that are input through various input terminals corresponding to various video signals such as a composite signal and a RGB signal.

The signal processing circuit 3602 performs processing for converting video signals other than the RGB signal into RGB signals, scaling processing for converting the resolution of the input video signal into the resolution of the DMD 3040 or various types of correction processing such as gamma correction. Then, the RGB signals on which these types of processing have been performed are output to the DMD drive circuit 3603 and the LED drive circuit 3070.

The signal processing circuit 3602 includes a synchronization signal generation circuit 3602a. The synchronization signal generation circuit 3602a generates synchronization signals for synchronizing the drive of the light sources 3201R, 3201G and 3201B and the drive of the DMD 3040. The generated synchronization signals are output to the DMD drive circuit 3603 and the LED drive circuit 3070.

The DMD drive circuit 3603 generates, based on the RGB signals from the signal processing circuit 3602, the DMD drive signals (on and off signals) corresponding to the R light, the G light and the B light. Then, according to the synchronization signals, the DMD drive circuit 3603 sequentially outputs, by time division, to the DMD 3040, the generated DMD drive signals corresponding to the R light, the G light and the B light, on an individual image in one frame basis.

The LED drive circuit 3070 drives the light sources 3201R, 3201G and 3201B based on the RGB signals from the signal processing circuit 3602. Specifically, the LED drive circuit 3070 generates LED drive signals by pulse-width modulation (PWM), and outputs the LED drive signals (drive currents) to the light sources 3201R, 3201G and 3201B.

In other words, the LED drive circuit 3070 adjusts the duty ratio of pulse waves based on the RGB signals, and thereby adjusts the amount of light output from each of the light sources 3201R, 3201G and 3201B. Thus, the amount of light output from each of the light sources 3201R, 3201G and 3201B is adjusted according to color information on the image, on an individual image in one frame basis.

The LED drive circuit 3070 also outputs the LED drive signals to the light sources according to the synchronization signals. Thus, it is possible to synchronize the timing of light emission of the light (the R light, the G light and the B light) emitted from the light sources 3201R, 3201G and 3201B and the timing of output of the DMD drive signals corresponding to the R light, the G light and the B light to the DMD 3040.

Specifically, while the DMD drive signal corresponding to the R light is being output, the R light having the amount of light suitable for the color information on the image at that time is emitted from the red light source 3201R. Likewise, while the DMD drive signal corresponding to the G light is being output, the G light having the amount of light suitable for the color information on the image at that time is emitted from the green light source 3201G. Furthermore, while the DMD drive signal corresponding to the B light is being output, the B light having the amount of light suitable for the color information on the image at that time is emitted from the blue light source 3201B.

By changing the amount of light emitted from the light sources 3201R, 3201G and 3201B according to the color information on the image, it is possible to increase the brightness of a projected image while reducing the power consumption.

The images of the R light, the G light and the B light are sequentially projected on the screen. However, since these images are switched at an extremely high speed, these images appear to be a color image free from flickering to the eye of the user.

Refer again to FIGS. 31 and 32. The light source units 320R, 320G and 320B, the light guide optical system 3030, the DMD 3040, the projection optical unit 3050, the control circuit 3060 and the LED drive circuit 3070 are arranged on the attachment surface that is the bottom surface of the body cabinet 3010.

The projection optical unit 3050 is present in a position apart from the center of the body cabinet 3010 toward the right side surface and is arranged from the approximate center in the front and back directions to the back portion (the fourth region). Here, the lens unit 3501 is arranged approximately in the center, and the curved mirror 3502 is arranged in the back portion.

The DMD 3040 is arranged in the front of the lens unit 3501. Specifically, the DMD 3040 is present in a position apart from the center of the body cabinet 3010 toward the right side surface and is arranged near the front surface (the first region).

The light source device 3020 is arranged on the left side (the third region) of the lens unit 3501 and the DMD 3040. The red light source 3201R and the blue light source 3201B are arranged on the upper side of the green light source 3201G, and are arranged in positions opposite each other with the green light source 3201G placed therebetween.

In the projection optical unit 3050, the curved mirror 3502 is arranged in a low position (a lower part of the fourth region) with respect to the bottom surface of the body cabinet 3010; the lens unit 3501 is arranged in a slightly high position (the position of an intermediate height of the fourth region) with respect to the curved minor. The DMD 3040 is arranged in a high position (an upper part of the first region) with respect to the bottom surface of the body cabinet 3010; the three light sources 3201R, 3201G and 3201B are arranged in low positions (lower parts of the third region) with respect to the bottom surface of the body cabinet 3010. Hence, the individual constituent components of the light guide optical system 3030 are arranged from the positions of arrangement of the three light sources 3201R, 3201G and 3201B to the front position of the DMD 3040; the light guide optical system 3030 is so configured as to be perpendicularly doubled when seen from the front of the projector.

In other words, the first lenses 3301R, 3301G and 3301B, the second lenses 3302R, 3302G and 3302B and the dichroic prism 3303 are arranged within a region surrounded by the three light sources 3201R, 3201G and 3201B. The hollow rod 3304 is arranged above the dichroic prism 3303 along upward and downward directions. From above the hollow rod 3304 to the side of the lens unit 3501, the mirror 3305, the relay lens 3306 and the mirror 3307 are sequentially arranged; the relay lens 3308 is arranged between the minor 3307 and the DMD 3040.

As described above, optical paths that are guided upward by the hollow rod 3304 from the light sources 3201R, 3201G and 3201B and that are then bent toward the lens unit 3502 are formed in the light guide optical system 3030. Thus, it is possible to reduce the length of the light guide optical system 3030 in leftward and rightward directions, and hence it is possible to reduce the area of the bottom surface of the body cabinet 3010. It is therefore possible to make the projector compact.

The control circuit 3060 is in the vicinity of the right side surface of the body cabinet 3010, and is arranged from the approximate center to the front end in front and back directions. In the control circuit 3060, various types of electrical components are mounted on a substrate having a predetermined pattern wiring formed; the surface of the substrate is arranged along the right side surface of the body cabinet 3010.

In the position of a right front corner portion of the body cabinet 3010 (the farthest end part of the first region) and the front end portion of the control circuit 3060, an output terminal portion 3604 through which the DMD drive signal generated by the DMD drive circuit 3603 is output is provided. This output terminal portion 3604 is formed with, for example, a connector. A cable 3401 extending from the DMD 3040 is connected to the output terminal portion 3604; the DMD drive signal is fed to the DMD 3040 through the cable 3401.

The LED drive circuit 3070 is arranged in a left back corner portion (the second region) of the body cabinet 10. The LED drive circuit 3070 is formed by mounting various types of electrical components on a substrate having a predetermined pattern wiring formed.

In the front (front end portion) of the LED drive circuit 3070, three output terminal portions 3701R, 3701G and 3701B are provided. To the output terminal portions 3701R, 3701G and 3701B are connected cables 3203R, 3203G and 3203B extending from the corresponding light sources 3201R, 3201G and 3201B, respectively; the LED drive signals (drive currents) are fed to the light sources 3201R, 3201G and 3201B through the cables 3203R, 3203G and 3203B.

Here, among the three light sources 3201R, 3201G and 3201B, the red light source 3201R is arranged closest to the LED drive circuit 3070. Hence, of the three cables 3203R, 3203G and 3203B, the cable 3203R for the red light source 3201R is the shortest.

As with the DMD 3040, the output terminal portion 3604 of the control circuit 3060 is arranged in the upper part of the first region. On the other hand, as with the light sources 3201R, 3201G and 3201B, the LED drive circuit 3070 is arranged in the lower part of the second region.

<<Variations and the Like>>

Among the embodiments described above, a plurality of embodiments can be combined. Specific values indicated in the above description are only illustrative; they can be naturally changed to various values. As variations of the above embodiments or explanatory notes for them, explanatory notes 1 and 2 will be described below. Unless otherwise a contradiction arises, the details of the explanatory notes can freely be combined.

[Explanatory Note 1]

The educational system of each of the embodiments can be formed either with hardware or a combination of hardware and software. When the educational system is formed with software, the block diagram of a portion provided by software indicates a functional block diagram of such a portion. By describing, as a program, a function achieved with software and executing the program on a program execution device (for example, a computer), the function may be achieved

[Explanatory Note 2]

Although, in the educational system of each of the embodiments, the display device utilized by the teacher and a plurality of students within the classroom is formed with the projector or the screen, the display device can be changed to an arbitrary type of display device (such as a display device using a liquid crystal display panel).

1. A presentation system comprising:
an image sensing portion which performs shooting such that a plurality of persons are included in a subject and which outputs a signal indicating a result of the shooting;
a speaker detection portion which detects, on an image, a speaker from the persons based on an output of the image sensing portion; and
an extraction portion which extracts, from the output of the image sensing portion, image data on an image portion of the speaker, as speaker image data based on a result of the detection by the speaker detection portion,
wherein a picture based on the speaker image data is displayed, by the presentation system, on a display screen that the persons can visually recognize.

2. The presentation system of claim 1, further comprising:
a sound signal generation portion which generates a sound signal corresponding to an ambient sound of the image sensing portion,
wherein the sound signal generation portion controls, based on the result of the detection by the speaker detection portion, a directivity of the sound signal such that, in the sound signal, a component of a sound coming from a direction of a position of the speaker is enhanced.

3. The presentation system of claim 2, further comprising:
a microphone portion which is formed with a plurality of microphones that individually output the sound signal corresponding to the ambient sound of the image sensing portion,
wherein the sound signal generation portion uses output sound signals of the microphones to generate a speaker sound signal in which the component of the sound coming from the speaker is enhanced.

4. The presentation system of claim 3,
wherein the speaker image data and data corresponding to the speaker sound signal are recorded, by the presentation system, so as to relate to each other.

5. The presentation system of claim 3,
wherein the speaker image data, data corresponding to the speaker sound signal and data corresponding to a time period for which the speaker speaks are recorded, by the presentation system, so as to relate to each other.

6. The presentation system of claim 1,
wherein, while a predetermined picture is displayed on the display screen, when the extraction portion extracts the speaker image data, a picture based on the speaker image data is displayed, by the presentation system, on the display screen by being superimposed on the predetermined picture.

7. A presentation system comprising:
a plurality of microphones which are provided to correspond to a plurality of persons, respectively and which output sound signals corresponding to sounds produced by the corresponding persons;
a sound recognition portion which performs sound recognition processing based on an output sound signal of each of the microphones to convert the output sound signal of each of the microphones into character data;
one or a plurality of display devices which the persons can visually recognize; and
a display control portion which controls content of a display produced by the display device according to whether or not the character data satisfies a predetermined condition.

8. A presentation system comprising:
an image sensing portion which shoots a subject and which outputs a signal indicating a result of the shooting;
a microphone portion which outputs a sound signal corresponding to an ambient sound of the image sensing portion; and
a speaker detection portion which detects a speaker from a plurality of persons based on an output sound signal of the microphone portion,
wherein an output of the image sensing portion with the speaker included in the subject is displayed, by the presentation system, on a display screen that the persons can visually recognize.

9. The presentation system of claim 8,
wherein the microphone portion includes a plurality of microphones that individually output the sound signal corresponding to the ambient sound of the image sensing portion, and
the speaker detection portion determines a sound incoming direction that is a direction in which a sound of the speaker comes, based on output sound signals of the microphones, in a relationship with a position where the microphone portion is arranged, and detects the speaker with a result of the determination.

10. The presentation system of claim 9,
wherein, by extracting a sound signal component coming from the speaker from the output sound signals of the microphones based on the result of the determination of the sound incoming direction, a speaker sound signal in which a component of the sound from the speaker is enhanced is generated by the presentation system.

11. The presentation system of claim 8,
wherein the microphone portion includes a plurality of microphones that correspond to the persons, respectively, and
the speaker detection portion detects the speaker based on a magnitude of an output sound signal of each of the microphones.

12. The presentation system of claim 11,
wherein, among the microphones, the output sound signal of the microphone corresponding to a person who is the speaker is used by the presentation system such that a speaker sound signal including a component of a sound from the speaker is generated by the presentation system.

13. The presentation system of claim 10,
wherein image data based on the output of the image sensing portion with the speaker included in the subject and data corresponding to the speaker sound signal are recorded, by the presentation system, so as to relate to each other.

14. The presentation system of claim 10,
wherein image data based on the output of the image sensing portion with the speaker included in the subject, data corresponding to the speaker sound signal and data corresponding to a time period for which the speaker speaks are recorded, by the presentation system, so as to relate to each other.

15. The presentation system of claim 9,
wherein, when, among the persons, there are a plurality of persons who produce sounds, the speaker detection portion detects, based on the output sound signal of the microphone portion, as a plurality of speakers, the plurality of persons who produce the sounds, and
the presentation system individually generates, from the output sound signals of the microphones, sound signals from the speakers.

16. The presentation system of claim 12,
wherein a sound signal based on the output sound signal of the microphone portion is reproduced by all or part of a plurality of loudspeakers, and
when the presentation system reproduces the speaker sound signal, the presentation system makes a loudspeaker corresponding to the speaker among the loudspeakers reproduce the speaker sound signal.

17. A presentation system comprising:
an image sensing portion which shoots a plurality of persons and which outputs a signal indicating a result of the shooting;
a personal image generation portion which generates, for each of the persons, based on an output of the image sensing portion, a personal image that is an image of the person so as to generate a plurality of personal images corresponding to the persons; and
a display control portion which sequentially displays, by performing a plurality of steps for the display, the personal images on a display screen that the persons can visually recognize,
wherein, when a predetermined trigger signal is received, information that a person corresponding to a personal image displayed on the display screen needs to be a speaker is provided by the presentation system.
